(19) United States
(12) Patent Application Publication
(10) Pub. No.: US 2026/0030707 A1
(43) Pub. Date: Jan. 29, 2026

(54) ADAPTABLE SYSTEM & METHOD FOR PROVIDING ACCESS TO AND/OR MANAGEMENT OF SUPPORT SERVICES & RELATED RESOURCES

(71) Applicant: CENTRAL IOWA SHELTER & SERVICES, Des Moines, IA (US)

(72) Inventors: Melissa O’Neil, Indianola, IA (US); Amber Valencia Tompkins, Altoona, IA (US); Dee Henriquez, Des Moines, IA (US)

(21) Appl. No.: 19/059,775

(22) Filed: Feb. 21, 2025

Related U.S. Application Data
(60) Provisional application No. 63/559,361, filed on Feb. 29, 2024.

(51) Int. Cl. G06Q 50/22; G06Q 10/0631

(52) U.S. Cl. CPC G06Q 50/22; G06Q 10/06315

(57) ABSTRACT

In one or more arrangements, a system if presented for providing access to and/or management of support services for prevention and/or mitigation of homelessness. In one or more arrangements, the system includes a front end system and a back end system. In one or more arrangements, the back end system includes a data server and a processing server. The processing server is configured to store data for a client user relating to eligibility for, availability of, and/or utilization of a plurality of support services. The front end system is configured to provide one or more user interfaces including a client user interface. In one or more arrangements, the client user interface is configured to permit the client user to access the data stored in the processing server to facilitate review of information for the plurality of support services.

### CROSS REFERENCE TO RELATED APPLICATION

This application claims benefit from U.S. Provisional Application No. 63/559,361 titled “SYSTEM & METHOD FOR PROVIDING ACCESS TO AND/OR MANAGEMENT OF SUPPORT SERVICES & RELATED RESOURCES”, and filed Feb. 29, 2024, the entirety of which is also incorporated herein fully by reference.

### FIELD OF THE DISCLOSURE

This disclosure relates generally to data storage, accessing, processing, and management. More specifically, and without limitation, this disclosure is directed to systems and methods for storage accessing and processing data to facilitate provision of access to and/or management of support services.

### OVERVIEW OF THE DISCLOSURE

Homelessness has been an ongoing and a longstanding challenge. While programs may attempt to alleviate immediate needs it can be difficult to address root causes and provide pathways to success. Rather, individuals tend to become trapped in an unintended cycle of dependency.

FIG. 1 shows a graphic illustrating the cycle of dependency. The cycle begins with support systems designed to aid those in need. But, without encouraging active participation and self-driven progress, individuals become idle. This idleness leads to decreased motivation, changing mindsets from proactive self-reliance to passive dependency on support systems. The shift towards dependency undercuts self-agency, leaving individuals less inclined to pursue self-sufficiency actively. Due to the Bubble Effect, the cycle perpetuates itself, making it harder for individuals to break free from homelessness and regain control of their lives. In the context of homelessness services the Bubble Effect can be understood as a phenomenon where temporary, surface-level solutions to homelessness inadvertently contribute to a cycle that keeps individuals within the state of homelessness rather than offering them a pathway out. These services, while crucial for immediate survival and well-being, are likened to “bubbles” at the bottom of the metaphorical waters of homelessness. Individuals, metaphorically drowning in their circumstances, grasp onto these bubbles for respite. However, these bubbles, designed primarily as emergency or short-term fixes, often lack the capacity to address the root causes of homelessness or equip individuals with the tools needed to achieve long-term stability and self-sufficiency. As illustrated in FIG. 2, it is envisioned that provision of support systems to empower individuals, foster motivation, and reinforce self-agency, the cycle of dependency can be overcome.

In one or more arrangements, a novel system for access to and/or management of support services is provided that takes a human centric approach to drive engagement and empower individuals to counteract the Bubble Effect and escape the cycle of dependency.

Therefore, for all the reasons stated above, and the reasons stated below, there is a need in the art for improved methods and systems for access to and/or management of support services. These and other objects, features, or advantages of the disclosure will become apparent from the specification, figures and claims.

### BRIEF DESCRIPTION OF THE DRAWINGS

FIG. 1 shows a graphic illustrating the cycle of dependency.

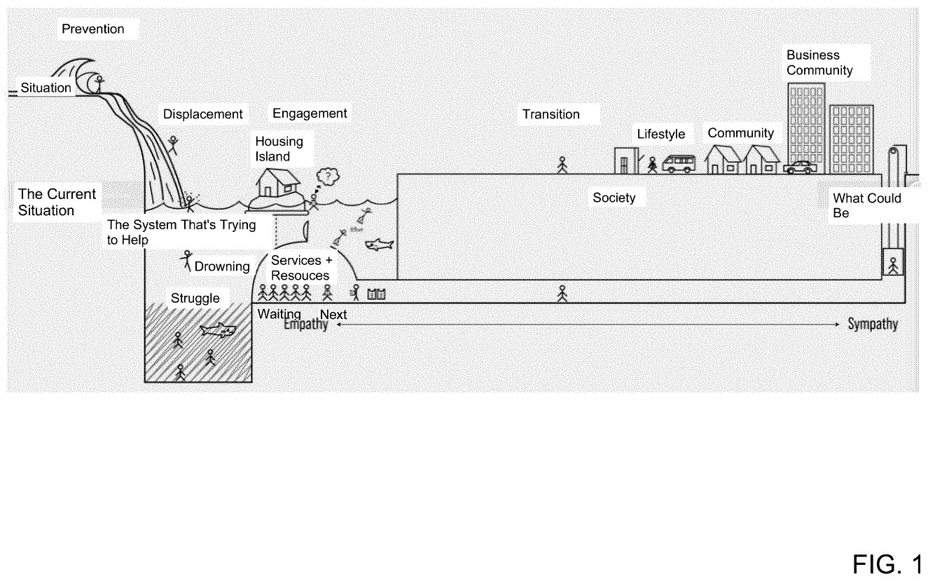

FIG. 2 shows a graphic illustrating individuals overcoming the cycle of dependency by focusing on empowerment of individuals.

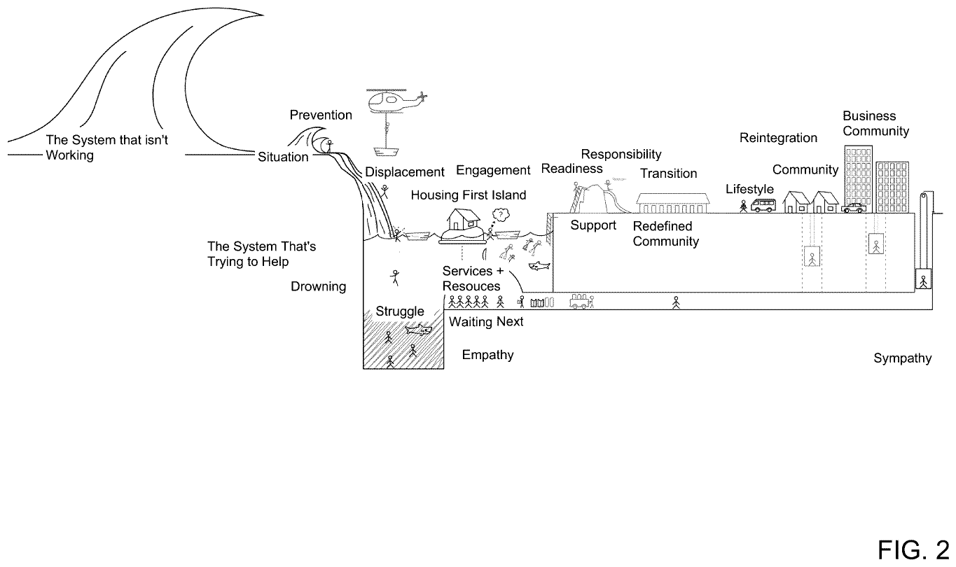

FIG. 3 shows a block diagram of an example implementation of a system, in accordance with one or more arrangements.

FIG. 4 shows a block organizational diagram of an example client user interface provided by the system, in accordance with one or more arrangements.

FIG. 5 shows a screenshot of an onboarding interface of an example client user interface, in accordance with one or more arrangements.

FIG. 6 shows a screenshot of an onboarding interface of an example client user interface, in accordance with one or more arrangements.

FIG. 7 shows a screenshot of an onboarding interface of an example client user interface, in accordance with one or more arrangements.

FIG. 8 shows a screenshot of an onboarding interface of an example client user interface, in accordance with one or more arrangements.

FIG. 9 shows a screenshot of an onboarding interface of an example client user interface, in accordance with one or more arrangements.

FIG. 10 shows a screenshot of an onboarding interface of an example client user interface, in accordance with one or more arrangements.

FIG. 11 shows a screenshot of an onboarding interface of an example client user interface, in accordance with one or more arrangements.

FIG. 12 shows a screenshot of an onboarding interface of an example client user interface, in accordance with one or more arrangements.

FIG. 13 shows a screenshot of an onboarding interface of an example client user interface, in accordance with one or more arrangements.

FIG. 14 shows a screenshot of an onboarding interface of an example client user interface, in accordance with one or more arrangements.

FIG. 15 shows a screenshot of an onboarding interface of an example client user interface, in accordance with one or more arrangements.

FIG. 16 shows a screenshot of an onboarding interface of an example client user interface, in accordance with one or more arrangements.

FIG. 17 shows a screenshot of an onboarding interface of an example client user interface, in accordance with one or more arrangements.

FIG. 18 shows a screenshot of an onboarding interface of an example client user interface, in accordance with one or more arrangements.

FIG. 19 shows a screenshot of an onboarding interface of an example client user interface, in accordance with one or more arrangements.

FIG. 20 shows a screenshot of a dashboard interface of an example client user interface, in accordance with one or more arrangements.

FIG. 21 shows a screenshot of a dashboard interface of an example client user interface, in accordance with one or more arrangements.

FIG. 22 shows a screenshot of a dashboard interface of an example client user interface, in accordance with one or more arrangements; the screenshot showing a resource section of the dashboard interface.

FIG. 23 shows a screenshot of a dashboard interface of an example client user interface, in accordance with one or more arrangements; the screenshot showing a resource section of the dashboard interface.

FIG. 24 shows a screenshot of a goals interface of an example client user interface, in accordance with one or more arrangements.

FIG. 25 shows a screenshot of a goals interface of an example client user interface, in accordance with one or more arrangements; the screenshot showing an interface screen for management of goals.

FIG. 26 shows a screenshot of a goals interface of an example client user interface, in accordance with one or more arrangements the screenshot showing an interface screen for adding a new goal.

FIG. 27 shows a screenshot of a goals interface of an example client user interface, in accordance with one or more arrangements; the screenshot showing an interface screen for review/interaction with an individual goal of a user.

FIG. 28 shows a screenshot of a goals interface of an example client user interface, in accordance with one or more arrangements; the screenshot showing an interface screen for review/interaction with an individual goal of a user.

FIG. 29 shows a screenshot of a goals interface of an example client user interface, in accordance with one or more arrangements; the screenshot showing an interface screen for review/interaction with an individual goal of a user.

FIG. 30 shows a screenshot of a goals interface of an example client user interface, in accordance with one or more arrangements; the screenshot showing a walkthrough interface for completion of an example initial questionnaire for the goal.

FIG. 31 shows a screenshot of a goals interface of an example client user interface, in accordance with one or more arrangements; the screenshot showing a walkthrough interface for completion of an example initial questionnaire for the goal.

FIG. 32 shows a screenshot of a goals interface of an example client user interface, in accordance with one or more arrangements; the screenshot showing a walkthrough interface for completion of an example initial questionnaire for the goal.

FIG. 33 shows a screenshot of a resource interface of an example user interface, in accordance with one or more arrangements.

FIG. 34 shows a screenshot of a resource interface of an example user interface, in accordance with one or more arrangements.

FIG. 35 shows a screenshot of a resource interface of an example user interface, in accordance with one or more arrangements; the screenshot showing a screen interface listing categories of resources for selection by a user.

FIG. 36 shows a screenshot of a resource interface of an example user interface, in accordance with one or more arrangements; the screenshot showing a screen interface listing categories of resources for selection by a user.

FIG. 37 shows a screenshot of a resource interface of an example user interface, in accordance with one or more arrangements; the screenshot showing a screen providing information for a selected resource.

FIG. 38 shows a screenshot of a resource interface of an example user interface, in accordance with one or more arrangements; the screenshot showing a screen providing a listing of resources for a selected category.

FIG. 39 shows a screenshot of an example community resource interface of an example user interface, in accordance with one or more arrangements.

FIG. 40 a screenshot of an example interface screen of the community resource interface for display of a particular community resource selected by a user, in accordance with one or more arrangements; the screenshot showing information for an example event.

FIG. 41 a screenshot of an example interface screen of the community resource interface for display of a particular community resource selected by a user, in accordance with one or more arrangements; the screenshot showing information for an example program.

FIG. 42 shows a screenshot of an example communication interface provided by a user interface, in accordance with one or more arrangements; the screenshot showing the communication interface configured to facilitate communication via email.

FIG. 43 shows a screenshot of an example communication interface provided by a user interface, in accordance with one or more arrangements; the screenshot showing the communication interface configured to facilitate communication via a chat interface.

FIG. 44 shows an example data processing system 200 that may be used to implement systems, circuits, components, and/or processes of back end system 14 and front end systems 16, in accordance with one or more arrangements.

### SUMMARY OF THE DISCLOSURE

In one or more arrangements, a system is presented for providing access to and/or management of support services for prevention and/or mitigation of homelessness. In one or more arrangements, the system includes a front end system and a back end system. In one or more arrangements, the back end system includes a data server and a processing server. The processing server is configured to store data for a client user relating to eligibility for, availability of, and/or utilization of a plurality of support services. The front end system is configured to provide one or more user interfaces including a client user interface. In one or more arrangements, the client user interface is configured to permit the client user to access the data stored in the processing server to facilitate review of information for the plurality of support services.

### DETAILED DESCRIPTION

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments that provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described as comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of support services and/or resources for prevention and/or mitigation of homelessness. However, the embodiments are not so limited. It is appreciated that the embodiments may be adapted for use in other applications which may be improved by the disclosed structures, arrangements and/or methods. The system is merely shown and described as being used in the context of support services and/or resources for prevention and/or mitigation of homelessness for ease of description and as one of countless examples.

### System 10:

With reference to the figures, a system and/or method for providing access to and/or management of support services and related resources for prevention and/or mitigation of homelessness is presented (system 10). In one or more arrangements, system 10 provides a user interface that connects current and new support services (also referred to as resources herein) to the most vulnerable populations, specifically focusing on homeless prevention while utilizing social determinants of health. In one or more arrangements, the system assists in ending homelessness by combining integrated healthcare, community and emergency services in a mobile or virtual form. In one or more arrangements, system 10 includes a behavioral insights engine that will tailor resource recommendations based on user provided information and/or geo technology. In one or more arrangements, the system is configured to perform data analytics to provide behavioral insights that help better understand behavioral triggers before, during, and after homelessness. In one or more arrangements, the user interface has a dashboard of available services/resources and helps mitigate redundancy and gaps in resources, assisting in deploying those resources to those in need creating a more effective, real time aggregator utilizing geo technology. In one or more arrangements, the system is configured to assess use of services/resources, to determine where people go, what resources are highly used and, what resources are not so as to effectively deploy resources and deter duplication of services and resources, thereby reducing burden on social infrastructures.

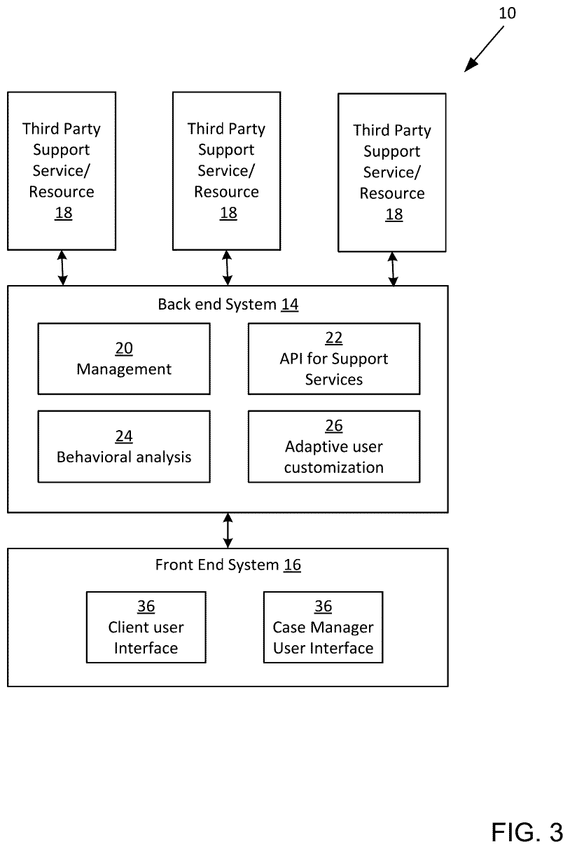

FIG. 3 shows a block diagram of an example implementation of system 10 in accordance with one or more arrangements. In this example arrangement, system 10 includes a front end system 16 and a back end system 14, which is communicatively connected to the front end system 16 and to one or more third party support services and/or resources, among other components.

### Back end System 14:

Back end system 14 is formed of any suitable size, shape, design, and/or technology and is configured to perform one or more functions for providing access and management of support services. In one or more arrangements, as is shown as one example, back end system 14 is configured to perform various processes to facilitate access to third party support services and/or resources (e.g. submission of applications and/or scheduling). In this illustrative example, the processes include but are not limited to, for example, management processes 20 (e.g., for support services, resources, and/or clients), application program interfaces (APIs) 22 to facilitate client interaction to third party systems (e.g., providers of third party services), behavioral analysis 24 for support services, resources, and/or clients), adaptive user customization processes 26, and/or, among other processes and/or functions.

### Management Processes 20:

In one or more arrangements, back end system 14 is configured to perform various management processes 20 to facilitate tracking of and/or coordination interaction between of client users and case managers and/or tracking and management of client goals and review of, application for, and/or use of available services. As described in more detail with reference to client user interface 36, in one or more arrangements, management processes 20 (or other process performed by back end system 14) may be configured to manage and track goals of clients, recommend customized action plans for indicated goals, and/or track client process on completion of items in the action plans. However, the arrangements are not so limited. Rather, it is contemplated that in some various arrangements, management processes 20 may be configured to perform various additional or alternative tasks.

### Application Program Interfaces 22:

In some arrangements, back end system 14 includes one or more application program interfaces (APIs) 22 that are configured to communicate with systems 18 for third party resources/services to facilitate, for example, client review of third party resources/services, retrieval of eligibility criteria and/or application requirements/documents, electronic submission of applications, and/or tracking status of such applications.

In some arrangements, back end system 14 may be configured to communicate with third party systems 18 using respective APIs. However, the arrangements are not so limited. Rather, it is contemplated that in some various arrangements, back end system 14 is configured to communicate with third party systems 18 using various means and methods including but not limited to, for example, supplier provided APIs, custom APIs, SQL queries, file downloads (e.g., application forms, guides, regulations, etc.), scraping of websites, automated submission of applications (e.g., via email, fax, FTP, Dropbox, and/or any other means or methods for communication of data).

### Behavioral Analysis Processes 22:

In some arrangements, back end system 14 is configured to perform one or more behavioral analysis processes to track and/or anticipate client use of services/tools and/or client preferences. For example, as described in more detail with reference to client user interface 36, in one or more arrangements, behavioral analysis processes 22 are configured to evaluate and determine personality type of users, user preferences, frequency of access to services, and/or other usage to facilitate user specific customization of system 10.

### Adaptive User Customization Processes 26:

In some arrangements, back end system 14 is configured to customize operation of system for client users based on data provided by behavioral analysis processes 22 and/or other data provided by user and/or acquired by system 10 to improve, for example, usability and efficiency of system 10 from a user perspective. For example, as described in more detail with reference to client user interface 36, in some arrangements, back end system 14 is configured to recommend, prioritize and/or otherwise rearrange how services and/or tools displayed in client user interface 36 to better assist in more quickly and/or easily accessing relevant services and/or information.

### Analytics Processes 30:

In some example arrangements, control system 106 is configured to perform various analytics processes 30, and/or other operations using data relating to client users and/or support services to derive additional data metrics and/or improve functionality/features of system. As some non-limiting examples, in one or more arrangements, analytics processes 30 may evaluate data on access to and/or utilization of support services, tools, and/or other features for example to identify services/tools/features that are most frequently used by client users, which may be used, for example, for better selection of resources for recommendation to client users.

Similarly, in some arrangements, analysis by analytics processes 30 may be used to correlate use of certain support services/tools/features with a particular set of attributes of client users (e.g., available resources, age, background, family status, etc.). Upon identification of a correlation of set of attributes with utilization of support services/tools/features, the system may configure/adjust an algorithm for generation of recommended resources to recommend the identified support services/tools/features to client users having the identified set of attributes.

Additionally or alternatively, in one or more arrangements, analytics processes 30 may be configured to determine suggested services/tools/features, settings, preferences based on usage and settings of client users having similar attributes.

Additionally or alternatively, in one or more arrangements, analytics processes 30 may be configured to assist in the processes performed by the application program interfaces 22, behavioral analysis processes 22, and/or adaptive user customization processes 26.

### Machine Learning:

In one or more embodiments, analytics processes 30 and/or other processes or components of system 10 may be configured to monitor, learn, and modify one or more processes, features, functions, and/or operations of the system 10. For instance, in one or more arrangements, analytics processes 30 may be configured to monitor and/or analyze data input by users and/or other data sources and learn, over time, improve processes and/or algorithms used in operation of system 10 (e.g., processes and/or algorithms used for determining suggested resources and/or generating the list of tasks/action plan for selected goals).

Such learning may include, for example, generation and refinement of classifiers and/or state machines configured to map input data values (e.g., client user information) to classifications (e.g., goals/suggested resources) or outcomes of interest or to operations to be performed by the system 10. In this manner, processes and/or algorithms used by system 10 may continue to improve automatically over time.

In various embodiments, analysis by analytics processes 30 and/or other processes or components of system 10 may include various guided and/or unguided artificial intelligence and/or machine learning techniques including, but not limited to: neural networks, genetic algorithms, support vector machines, k-means, kernel regression, discriminant analysis and/or various combinations thereof. In different implementations, analysis may be performed locally, remotely, or a combination thereof.

### Front End System 16:

In one or more arrangements, system 10 includes a front end system 16. Front end system 16 is formed of any suitable size, shape, design, and/or technology and is configured to provide one or more user interfaces 36 for end users to communicate and interact with back end system 14 to facilitate use of system 10 by clients, case managers, and/or other end-users.

The user interfaces 36 provided by front end system 16 may be formed of any suitable size, shape, and design, and/or technology and is configured to permit end users (e.g., clients and/or case managers) to interact with back end system 14 to facilitate input, access to, and/or processing of relevant data relating to support services, related resources, and/or client.

For ease of explanation, front end system 16 may be primarily described with reference to a client user interface 36 for use by client users. However, the arrangements are not so limited to the user interfaces described herein. Rather, it is contemplated that in some various arrangements, system 10 may include any number of user interfaces configured for access by various categories of end users. For example, in one or more arrangements, system 10 includes multiple user interfaces for use by the different types of end-users. For instance, in some various different arrangements, front end systems 16 includes a first user interface 36 for clients and a second user interface 36 for case managers.

### Automated Reconfiguration of Client User Interface 36:

In one or more arrangements, front end system 16 and/or back end system 14 are configured to dynamically reconfigure a client user interface 36 (e.g., via processes 26) to personalize the client user interface 36 for each user and thereby improve usability and functioning of the system 10.

Automated Rearrangement of Services and/or Tools:

In one or more arrangements, client user interface 36 is configured to automatically rearrange services and/or tools to assist users in more quickly and/or easily accessing services and/or relevant information.

### Prioritization and Rearrangement of Tasks:

It is recognized that in the context of providing assistance to homeless persons, users may be presented with a multitude of different services with different and potentially complex eligibility criteria. As a result, it can be difficult for users to independently browse and locate services for which they qualify. It is suspected that each time a person views and inquires about and/or applies for an available service that they are not eligible for, they are less likely to inquire about additional services that are available. Efforts are further frustrated in that user information needed to determine eligibility may not be readily available (e.g., government records, residential address, etc.).

Currently, case managers are frequently employed to personally inquire about user's needs and status and guide the users toward relevant services that they may be eligible for. However, due to limited resources, this approach can only assist a limited number of persons.

In one or more arrangements, client user interface 36 is configured to prompt new users to provide information relating to their status and needs and determine a customized action plan for the user to review and/or apply for services for which they may be eligible. Such information may include but is not limited to, for example, whether the user currently has somewhere to stay and for how long, availability and/or need for food, availability and/or need for healthcare, available methods of contact, age, sex, dependents, and/or any other relevant information.

For example, in one or more arrangements, a client user is prompted during the initial sign on to indicate if there are any particular categories of resources/services that are a priority for the user. If selected, the system adds the selected item as a goal to be completed by the client user and creates a customized action plan for the goal. The client user may select additional goals at a later time and/or additional goals may be recommended by the system based on user information.

In one or more arrangements, the customized action plan lists recommended tasks to be reviewed/completed to help move the user toward the selected goal. In one or more arrangements, the plan indicates a list of various tasks intended to help the user acquire access to resources related to the specified goal. In some various arrangements, the action plan may include various recommended tasks related to advancement of the selected goal such as, for example: completion of a goal-specific questionnaire, consultation with a subject matter advisor, review and/or application for services related to the goal, and/or any other relevant action and/or task.

In some arrangements, the items in the action plan may be filtered/prioritized/rearranged based on provided user status/eligibility as described herein. For example, in one or more arrangements, system 10 is configured to prioritize services in the customized action plan based on specific needs of the user (e.g., shelter, food, healthcare, etc.), likelihood of eligibility, and/or ease of application. In one or more arrangements, client user interface 36 is configured to automatically reorder services displayed in a list of recommended services for review based on the determined prioritization of the services. By reordering the recommended services based on the user customized action plan, the user is initially prompted to review/apply for services that are more relevant, are easier to apply for, and/or for which the user is more likely to be eligible for. In this manner, users are more likely to achieve recognizable results in their initial attempts to access services using the system, thereby increasing the probability of continued use and the provision of access to more available services.

### Example Prioritization/Rearrangement,

Various arrangements may utilize various different methods and/or means for prioritization of services and/or tools in the client user interface 36 (e.g., in a main dashboard and/or in customized action plans for user goals). As one non-limiting example, in one or more arrangements, services in a user customized action plan may be prioritized as follows:
1) For each service, determine if client user is Eligible, Ineligible, or if Eligibility is Unknown.
2) Remove ineligible services and prioritize a first category for eligible services over a second category for services with unknown eligibility.
3) In each category, sort services by ease of application and approval.
4) Reprioritize services to move essential services (e.g., shelter and food) for which there is immediate need by the user to the top of the list.

### Rearrangement Based on Use

It is recognized that in the context of providing assistance to homeless persons, online tools are most frequently accessed via mobile devices, which limit the information and service gateways that can be displayed at a given time. While a larger number of information and services can be organized into nested levels of menus, such multi-level organization makes it more difficult to browse and locate particular services and/or information. It has been observed that users may spend a significant amount of time relocating desired services in a user interface to access information and/or apply for access to services.

In one or more arrangements, system 10 is configured to track how frequently services and/or tools are accessed by users in the client user interface 36, and rearrange buttons or icons used to access the services/tools to make frequently used services and/or tools more accessible. For example, in one or more arrangements, client user interface 36 may present buttons or icons for the services/tools in a scrollable list and dynamically rearrange positions of the buttons or icons in the list to move more frequently accessed services/tools forward toward a front of the list and lesser accessed services/tools back toward and end of the list. In this manner, users can more readily find and access frequently used services/tools.

However, embodiments are not so limited. Rather, it is contemplated that the client user interface 36 may be configured to arrange buttons and/or icons for services/tools on various criteria including but not limited to, for example, frequency of use, actions taken by users, user eligibility for the services, and/or any other criteria.

### Personality Type Customized Interface:

It is recognized that in the context of human services, persons of different personality types may have different interests in services they want to utilize and/or may have different preferences in how they would like to be contacted and/or interact with system 10.

In one or more arrangements, system 10 is configured to classify users into a set of personality types (e.g., based on questions/testing via the client user interface 36) and adjust client user interface 36, methods of interactions, service/tool suggestions, and/or customized action plan based on the personality types. This human centric approach is believed to optimize engagement and utilization of the system and available services/tools to best serve a diverse set of users.

As an illustrative example, some personality types tend to prefer social engagement whereas other personality types may prefer solitary or less crowded situations.

In one or more arrangements, system 10 may filter or sort available services/tasks/activities to better fit social preferences of the determined personality type of the user. As an illustrative example, for the category of veteran services, system 10 might recommend/prioritize services/events that meet in a group or public setting for personality types that are more social. Conversely, system 10 might recommend/prioritize services that operate on a one-on-one/buddy model for personality types that are less social.

As another illustrative example, one or more arrangements, system 10 may adjust overview/assistance steps for various tasks of a user specific action plan based on the determined personality type. For example, some personality types may prefer to meet with an advisor and follow their recommendations on available options for services, whereas other personality types may prefer to read through materials on their own and make their own determination.

As yet another illustrative example, one or more arrangements, system 10 may set default methods for contacting and/or meeting with a user based on the determined personality type. For example, depending on the personality type users may prefer to consult with an advisor/case manager via messaging/txt, phone call, video call, in person at an organization's offices, and/or have an advisor/case manager come to the user's location. In one or more arrangements, system 10 may be configured to initially suggest a method of contact that best matches the method generally preferred by the determined personality type of the service.

However, the arrangements are not limited to these illustrative examples. Rather, it is contemplated that some various arrangements may utilize various additional or alternative adjustments to the client user interface 36 (or other actions), based on the determined personality type of a user.

### Not Limited to Disclosed Processes for Prioritization/Rearrangement

The arrangements are limited to the example processes for prioritization discussed herein. Rather, it is envisioned that some various arrangements may utilize various different methods and/or means for selection, prioritization, and/or arrangement of tools and/or services in the client user interface 36. Moreover, various different arrangements may utilize various different criteria for selection, prioritization, and/or arrangement including but not limited to, for example, frequency of access, time since last access, eligibility, relevance to user status, user selected interests, user location, and/or any other relevant criteria.

In one or more arrangements, criteria for selection, prioritization, and/or arrangement may be adjusted via settings menu of a case manager user interface 36. Customization allows different staff or groups of a particular organization utilizing system 10 to adjust automated selection, prioritization, and/or arrangement to better meet the particular needs of the organization. Customized settings may be stored, for example, in a settings file of back end system 14.

### Example Client User Interface 36

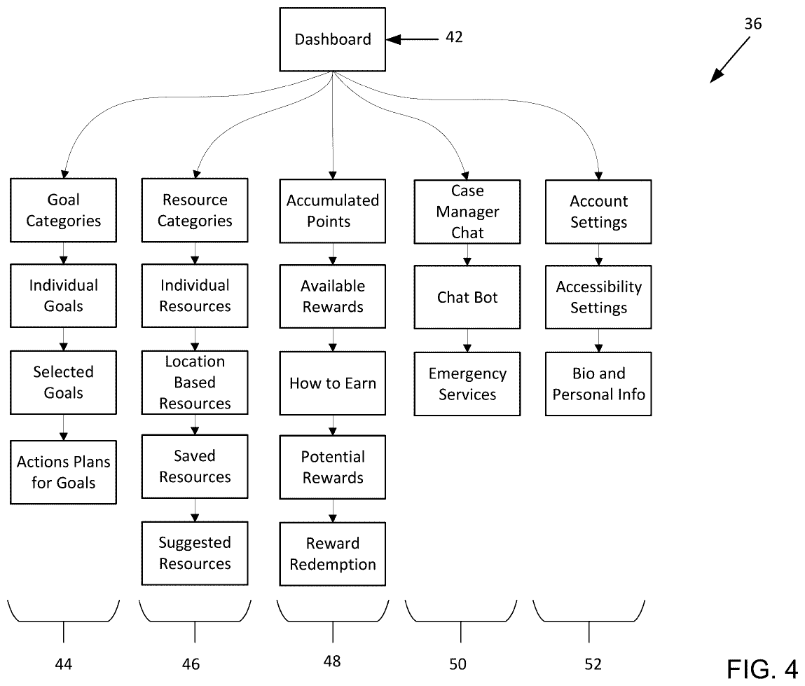

In various different arrangements, client user interface 36 may include a number of different menus, screens, links, and/or interfaces to facilitate navigation and access to various available services, tools, information and/or features. FIG. 4 shows a block organizational diagram of an example client user interface 36 provided by front end system 16, in accordance with one or more arrangements. In this example organization, the client user interface 36 includes one or more sub-interfaces for various features/information accessible from a primary dashboard including, for example, goals 44, resources 46, rewards 48, and communication 50, and settings 52.

In this example, interface 44 provides access for a user to browse goal categories, individual goals, selected goals, and action plans generated for selected goals. In this example, interface 46 provides access for a user to browse categories of services, individual services, saved services, and suggested services. In this example, interface 48 provides access for a user to view accumulated rewards points, available rewards, information on how to earn rewards, potential awards, and an interface for redemption of rewards. In this example, interface 50 provides access to various communication channels for assistance including but not limited to, for example, communications with a case manager, chat bot, and/or emergency services. In this example, interface 50 provides access for a user to view and adjust account settings, accessibility settings, and/or user bio and personal information.

### Onboarding Interface 60

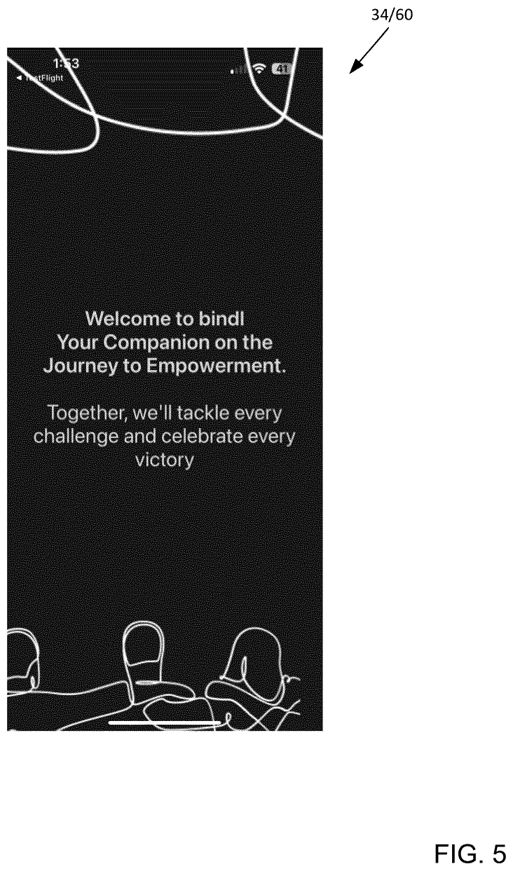

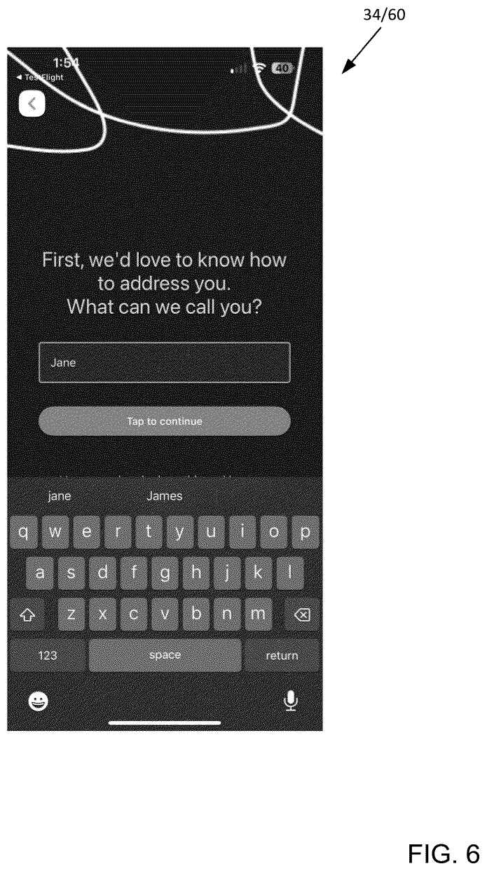

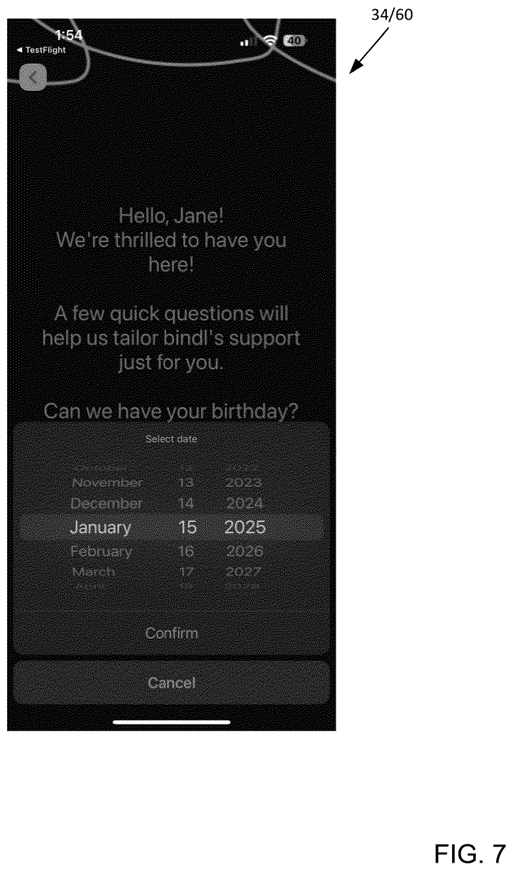

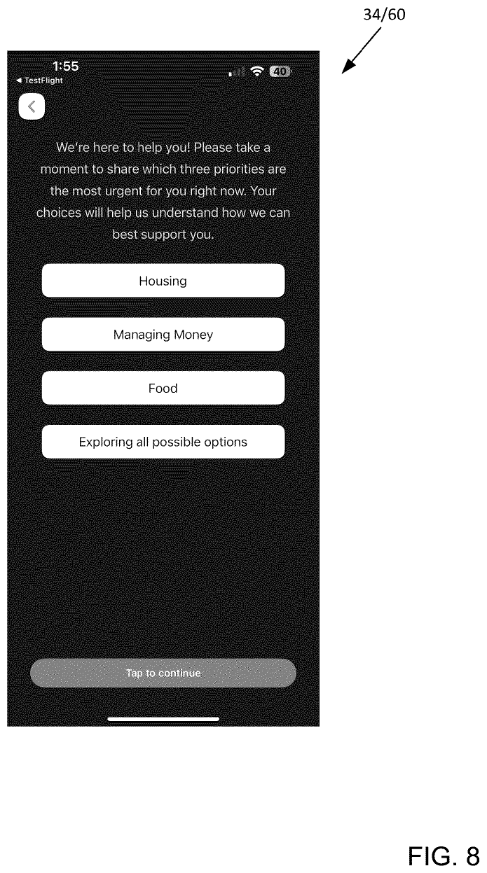

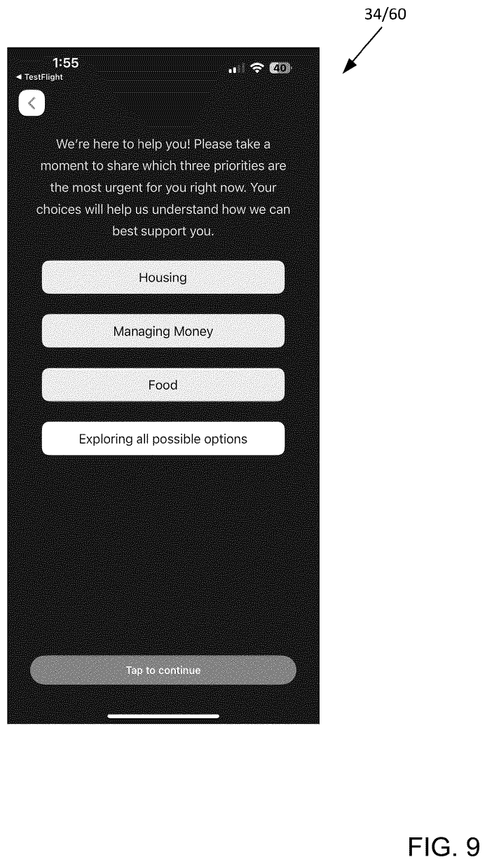

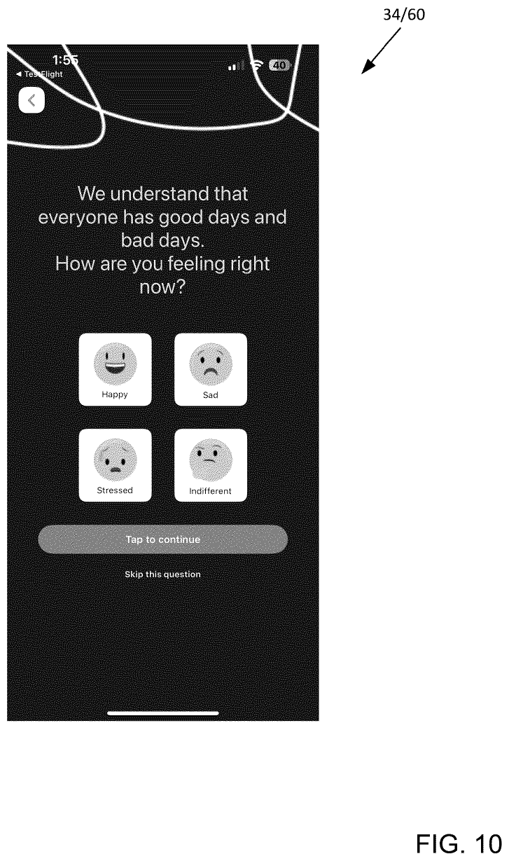

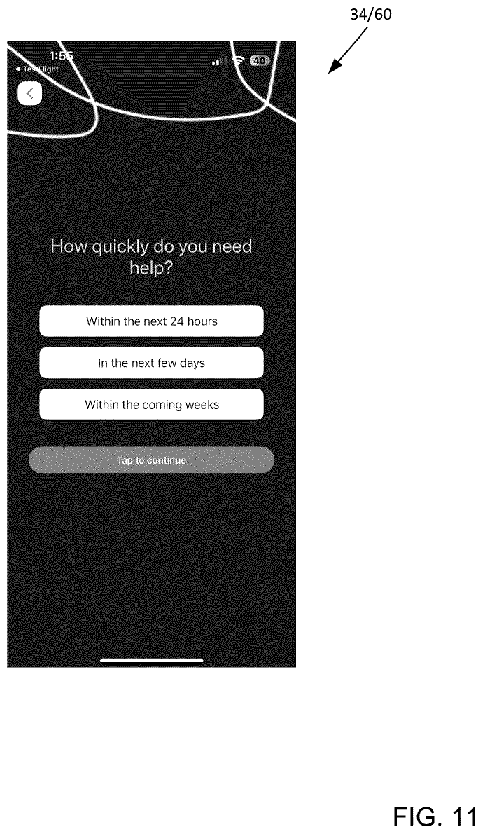

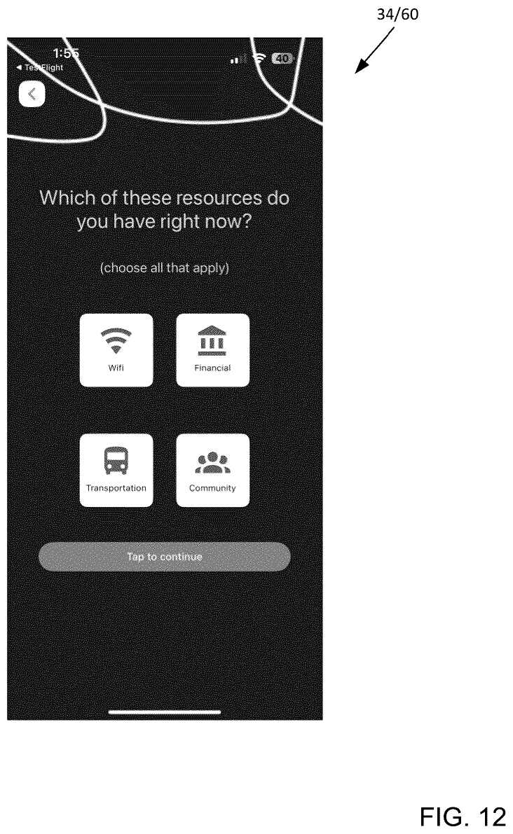

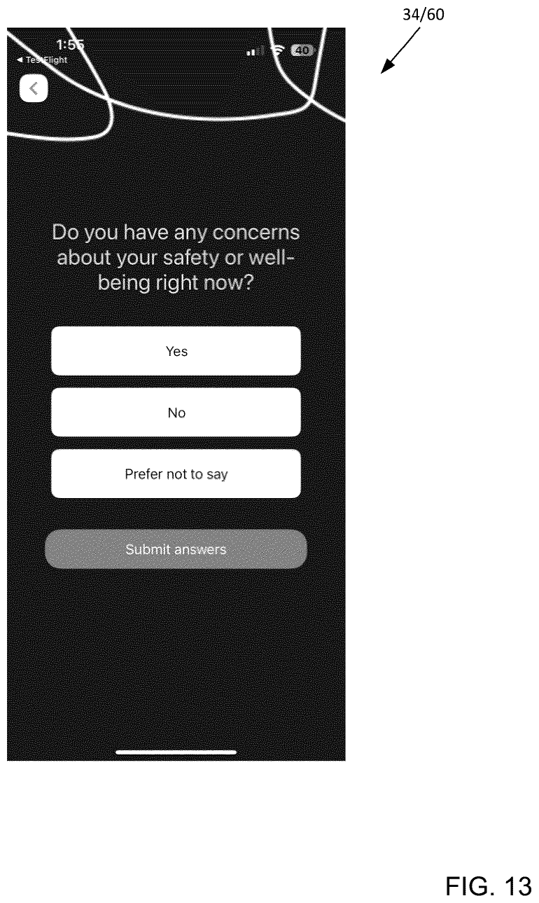

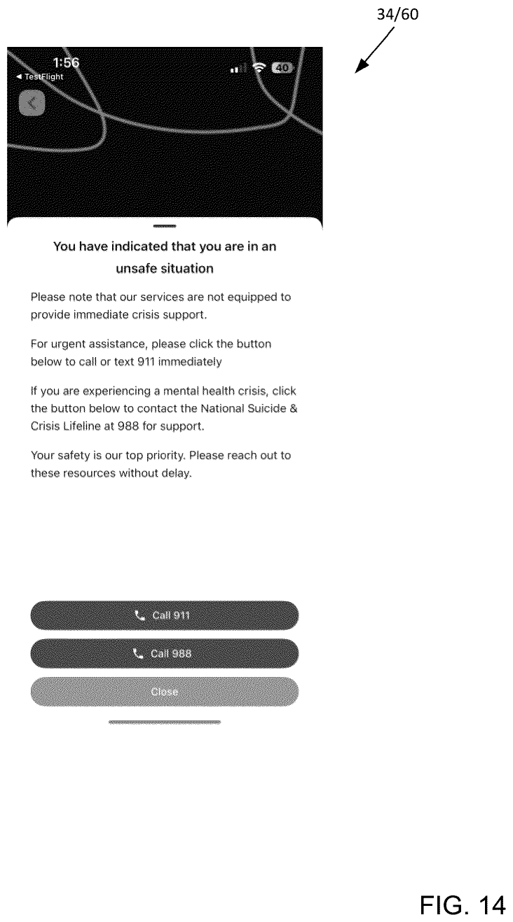

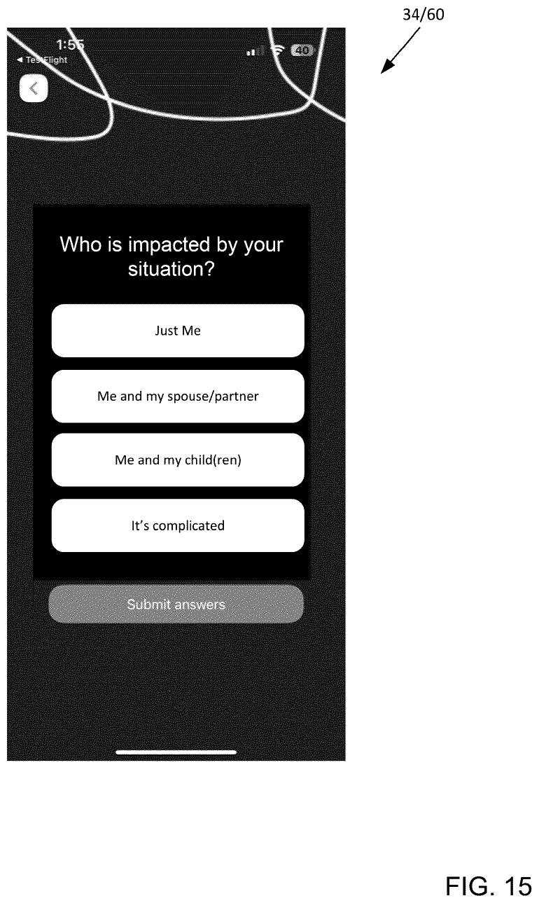

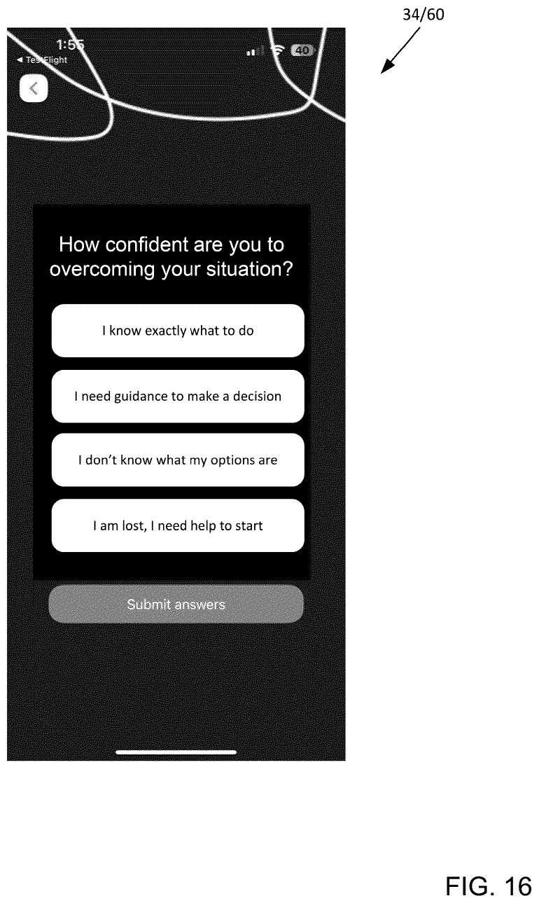

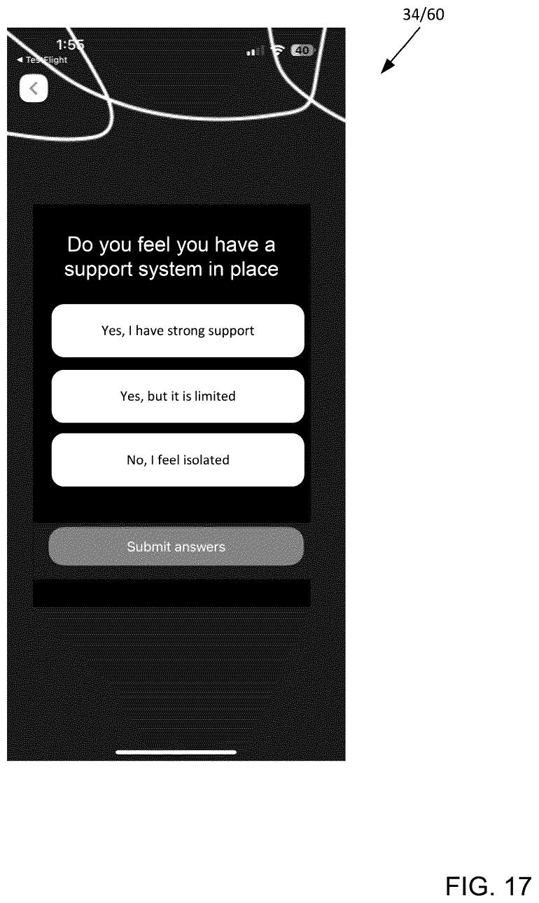

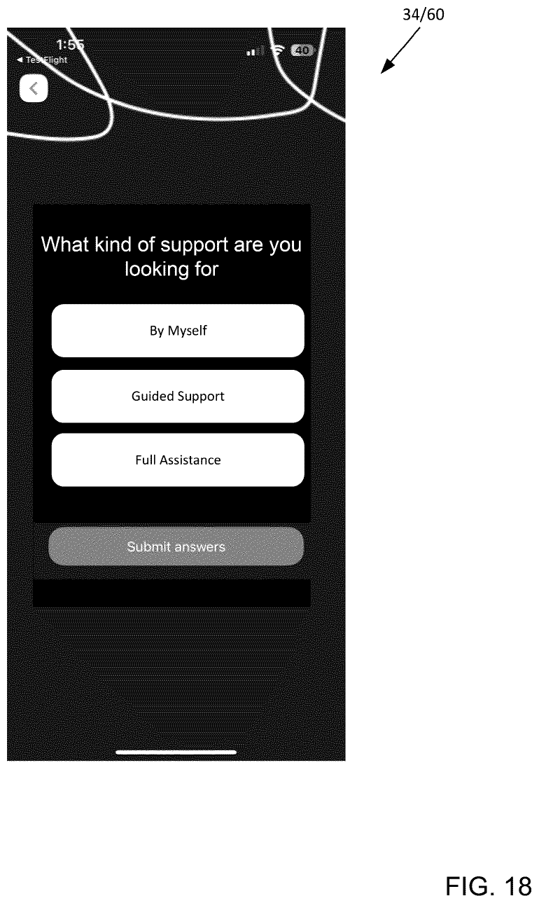

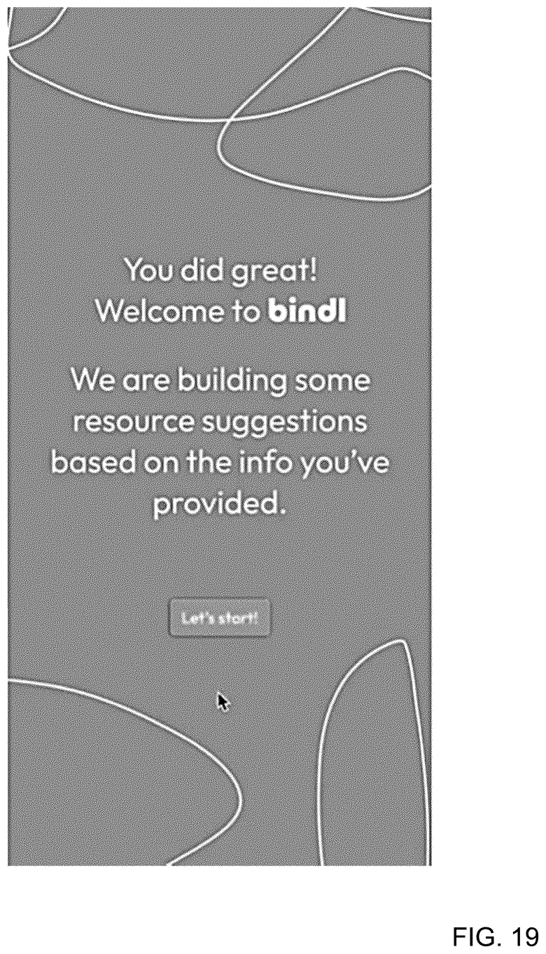

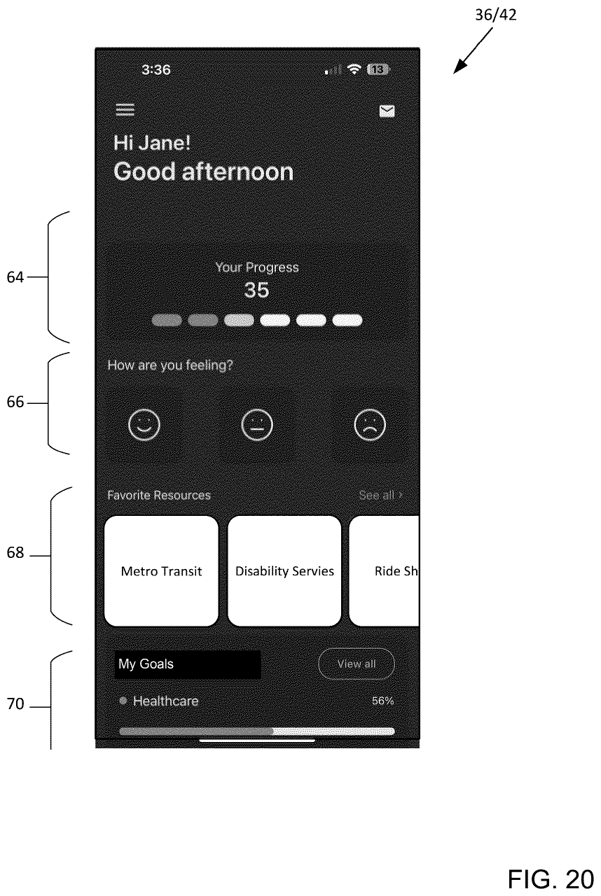

FIGS. 5-20 screenshots of an example client user interface 36 in accordance with one or more arrangements; the view showing screens of an onboarding interface 60 presented for initial onboarding of a user.

In this example, the screens shown in FIGS. 5-20 prompt a user to enter some initial information to categorize the user and identify from services that are of particular need to the user.

In this example arrangement, the client user is prompted to provide a name, birthdate, priorities for needed resources, current emotional status, timeframe required assistance, resources the client user currently has available, and/or safety/wellbeing status. However, the arrangements are not so limited. Rather, it is contemplated that in some various arrangements, client user interface 36 may be configured to prompt a client user to provide various additional or alternative information during an initial onboarding.

### Dashboard Interface 42:

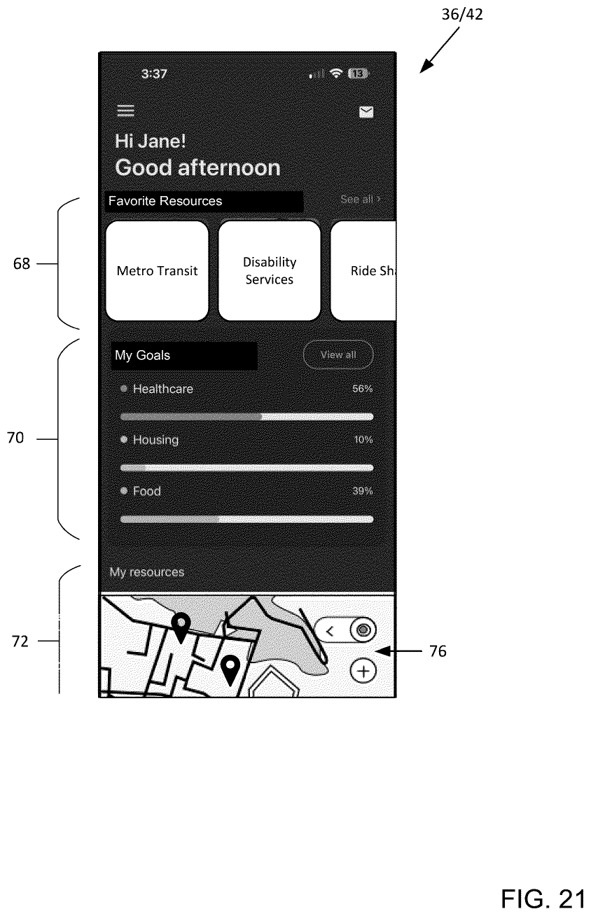

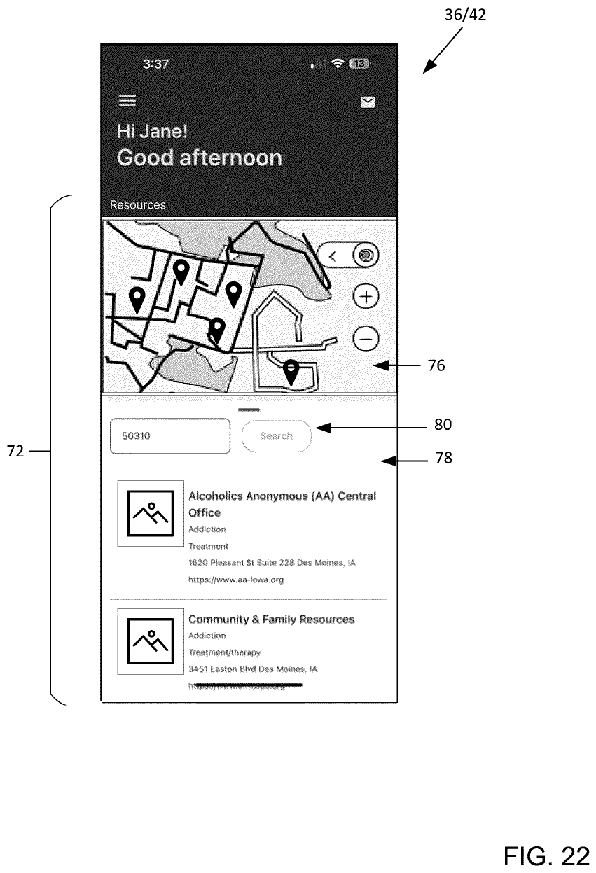

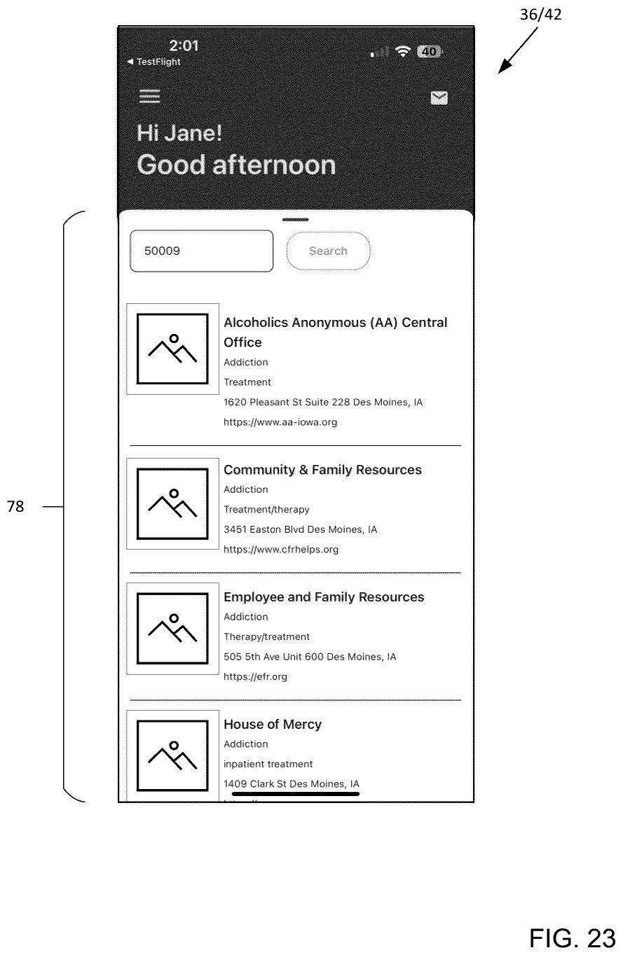

FIGS. 21-23 show screenshots of a dashboard interface 42 of an example client user interface 36 in accordance with one or more arrangements. In the arrangement shown, dashboard interface 42 is configured to provide access for a user to navigate to various sub-interfaces (e.g., goals 44, resources 46, rewards 48, communication 50, settings 52, etc.). In the example arrangement shown, dashboard interface 42 also provides a summary of various relevant information along with links to recently accessed, frequently used/prioritized items (e.g., goals and/or resources).

In the arrangement shown, dashboard interface 42 includes a progress section 64, an emotional status section 66, a favorite resource section 68, a user goals section 70, and a user resources section 72. In this example arrangement, progress section 64 includes a progress indicator bar indicative of an overall progress of completing tasks for the goals selected by the user. In this example arrangement, emotional status section 68 includes an interface for a user to input their current emotional state for tracking and/or automated reconfiguration of client user interface 36.

In this example arrangement, favorite resources section 68 includes a side scrollable list of resources that are frequently used by the user.

In this example arrangement, user goals section 70 shows a list of a set of selected goals for the user along with a progress summary indicator for each goal. In this example arrangement, a user may select one of the goals to view additional details and/or continue working on the goal (e.g., in goal interface 44). In this example arrangement, user goals section 70 includes a button for a user to view all goals of the user (e.g., in goal interface 44).

In this example arrangement, user resource section 72 includes a graphical map interface 76 with geomarkers showing locations of a user's selected resources relative to a current location. This graphical map interface 76 can make it easy for a user to assess which resources are nearby and/or assist in navigating to resources. In this example arrangement, user resource section 72 also includes a pull up list interface 78 showing nearby resources of a user. In one or more arrangements, a user can select a resource from the pull up list interface 78, for example, to view additional information for the resource and/or navigate to the resource. In one or more arrangements, as is shown pull up list interface 78 includes a search bar 80 to permit a user to search for additional resources (e.g., by name, location, type of service, or any other search criteria).

### Goals Interface 44:

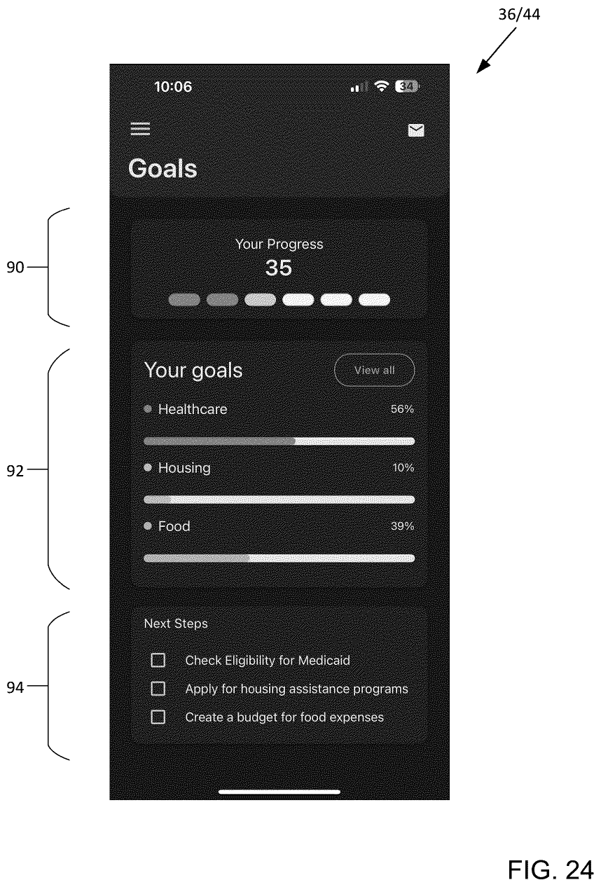

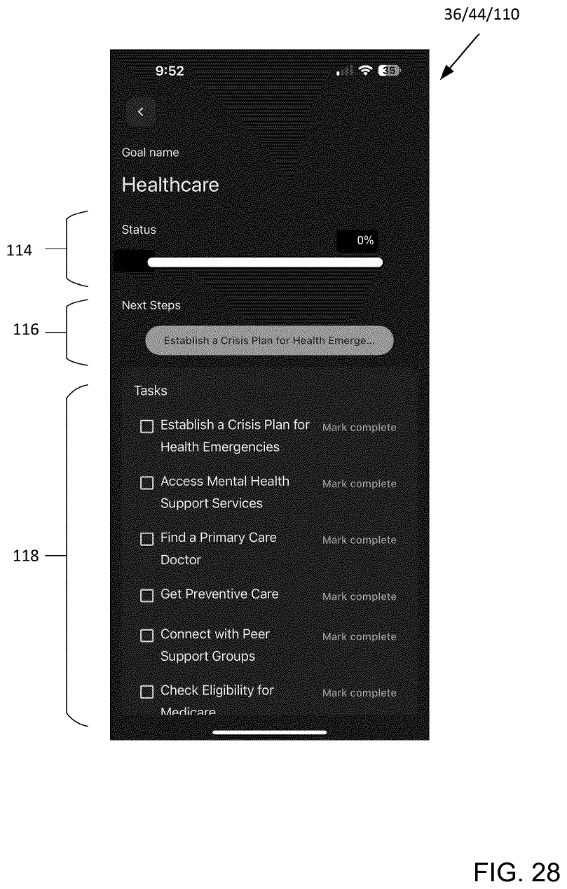

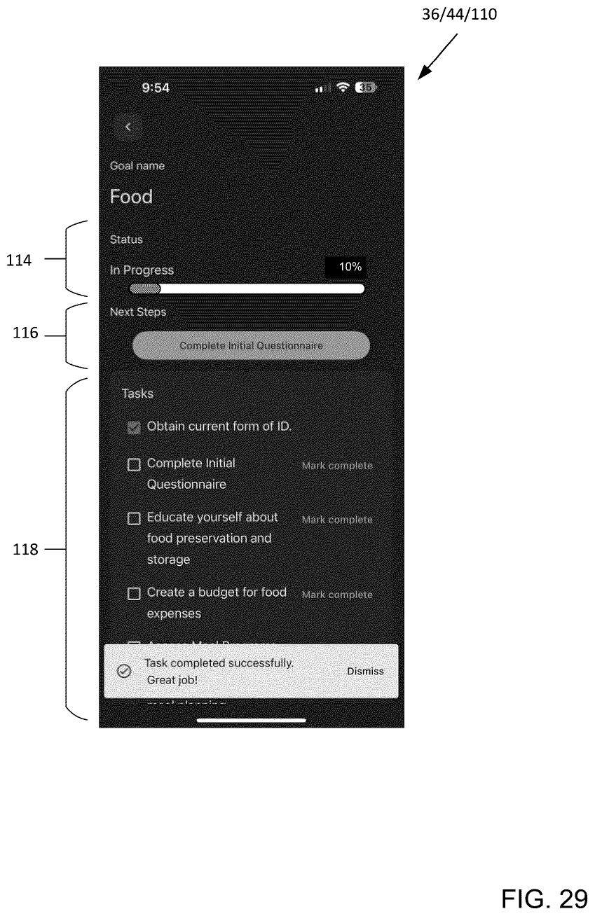

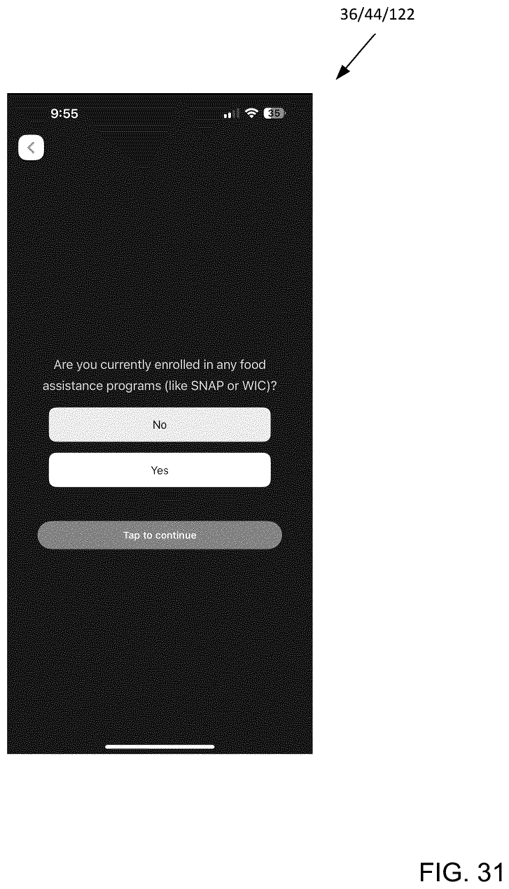

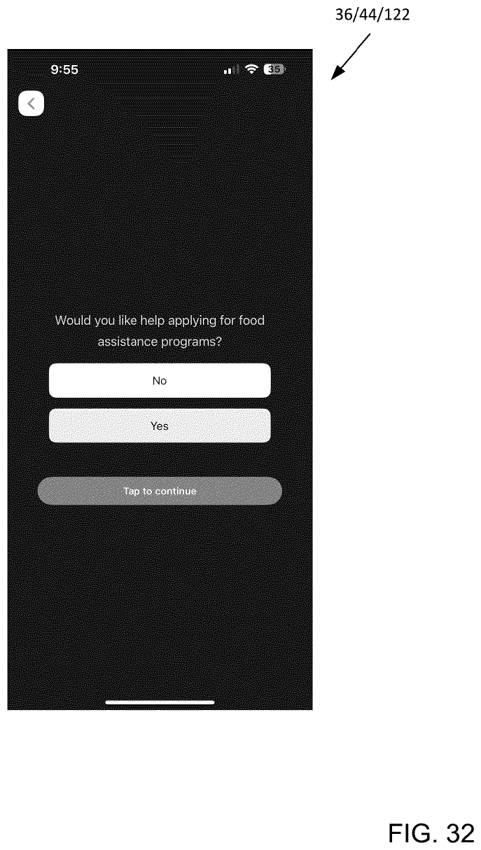

FIGS. 24-32 show screenshots of an example goals interface 44 of client user interface 36 in accordance with one or more arrangements. In the arrangement shown, as one example, goals interface 44 is configured to provide access for a user to navigate to view, modify and/or progress through selected and/or suggested goals. In this example, goals interface 44 has an overall progress bar 90 configured to show an overall progress of goals selected by and/or recommended for a user.

In this example, goals interface 44 also includes a user goal section 92, configured to display a listing of the user. In one or more arrangements, as is shown, user goal section 92 includes respective progress indicators (e.g., progress status bars) to indicate user progress in completing tasks for the respective goals. In this example, goals interface 44 also includes a next steps section 94 listing next steps and/or tasks for the goals listed in user goals section 92. In one or more arrangements, a user can select one of the goals in the list 92 to view, modify and/or progress through steps/tasks for the particular goal.

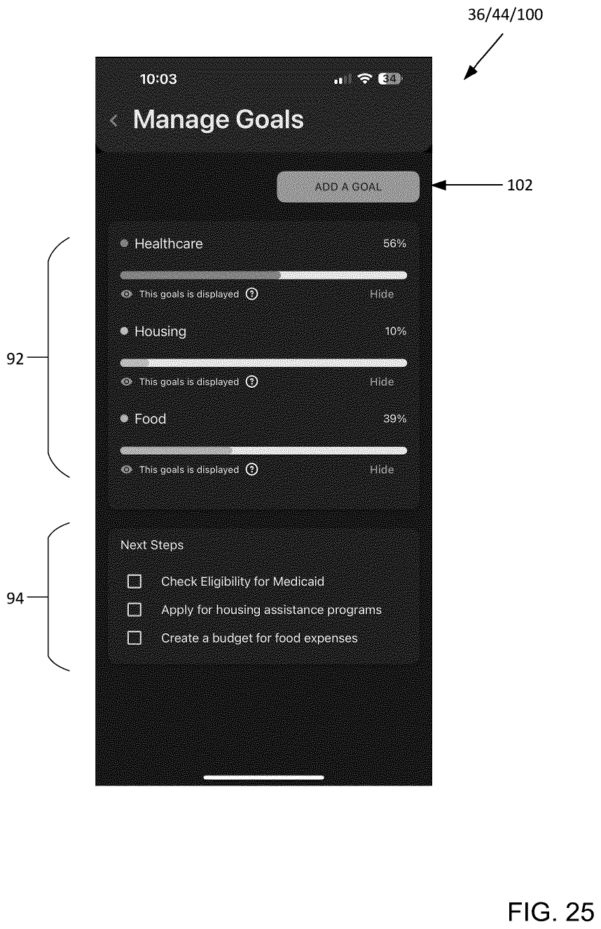

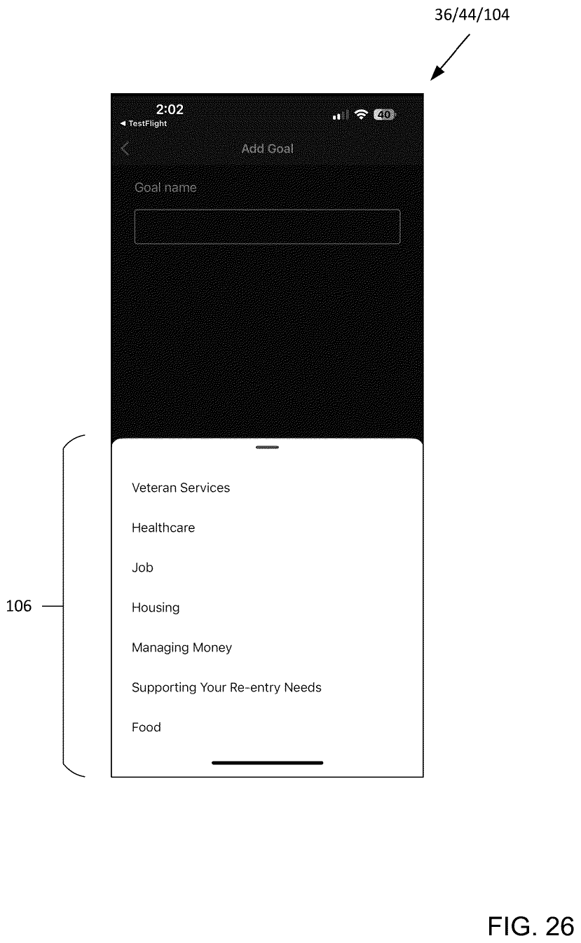

In one or more arrangements, user goal section 92 displays a listing of recent and/or prioritized goals of the users and a button to view all goals of the user (e.g., in manage goals interface screen 100 shown in FIG. 25). In the example arrangement shown in FIG. 25, manage goals interface screen 100 is similar to goals interface 44 but list all goals that have been selected by/for the user and includes a button 102 to add additional goals. FIG. 26 shows a screenshot of an example interface screen 104 for adding a new goal for the user (e.g., in response to pressing button 102). In this example, interface screen 104 includes a list 106 of goals for selection.

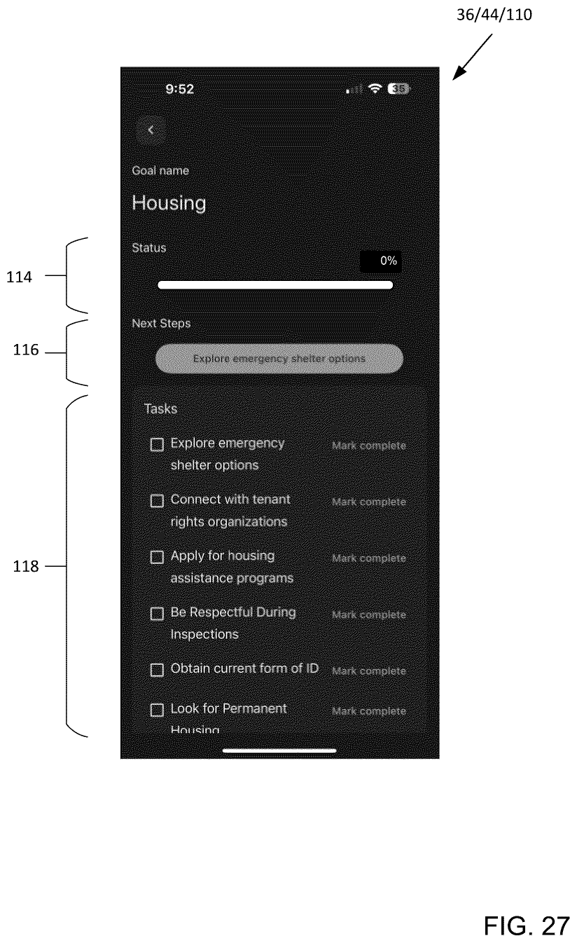

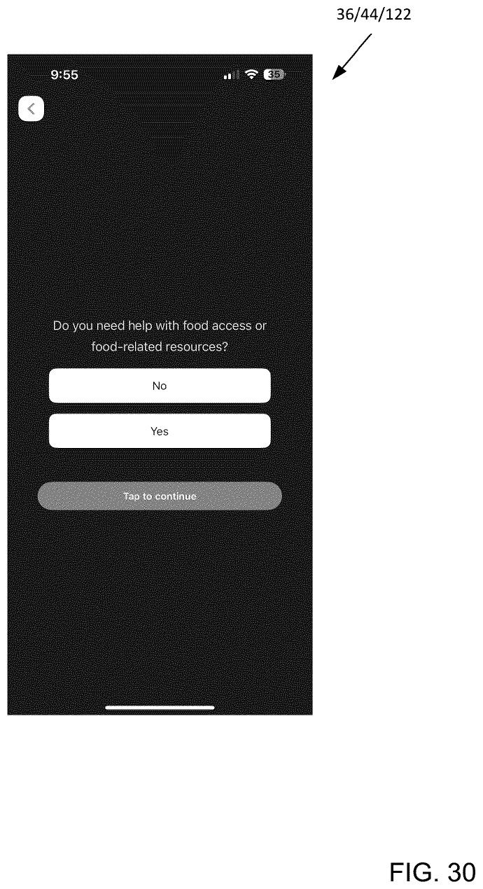

FIGS. 27-29 show screenshots of example interface screens 110 for display and interaction with individual goals of a user. In this example arrangement, interface screens 110 have a status section 114 showing completion status of the goal (e.g., progress bar or another indicator). In this example arrangement, interface screens 110 also have a next steps section 116 indicating the next suggested step to be performed in pursuit of completion of the goal. In some various arrangements, next steps section 116 includes a button to display instructions and/or initiate a walkthrough for completion of the step/task by the user. As one example, FIGS. 30-32 show screenshots of an example walkthrough interface 122 for completion of an example initial questionnaire for the goal (e.g., food access). In this example arrangement, interface screens 110 also have a tasks section 116, showing a listing of all tasks for a goal. In this illustrative example, tasks section 116 has a checklist display interface permitting a user to check off tasks as they are completed.

### Resource Interface 46:

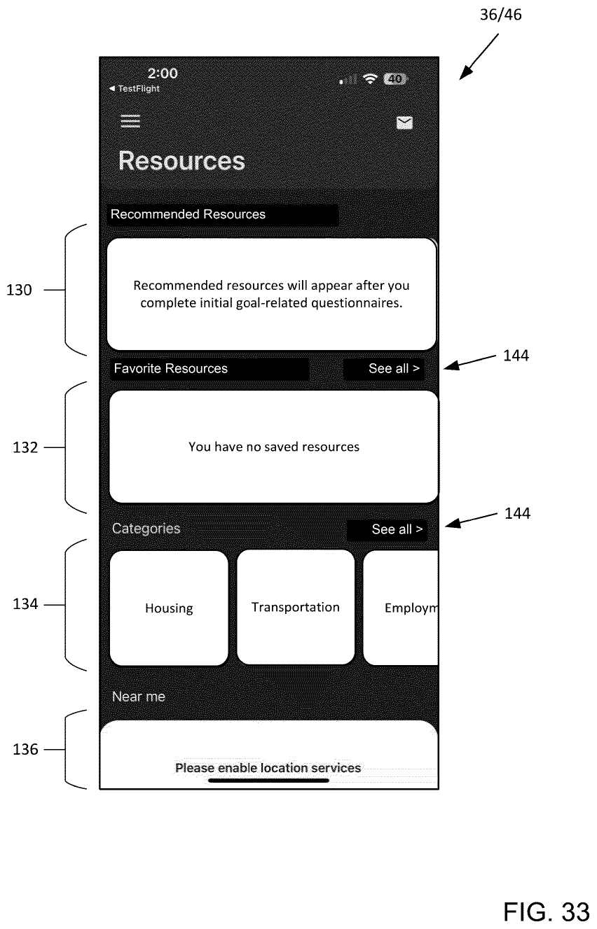

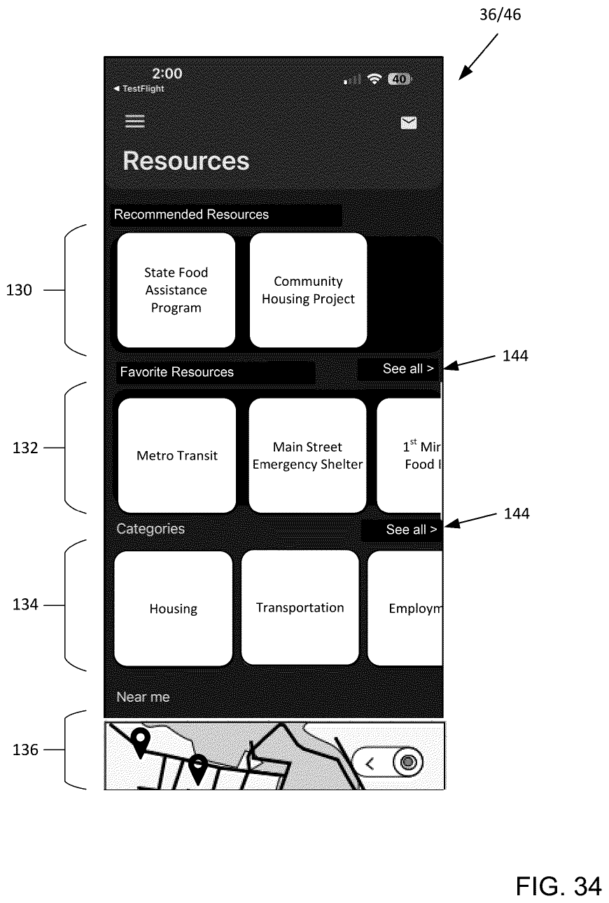

FIGS. 33-41 show screenshots of an example resource interface 46 of user interface 36 in accordance with one or more arrangements. In the arrangement shown, as one example, resource interface 46 is configured to provide access for a user to navigate to, view, and/or utilize various available resources.

### Recommended Resource Section 130:

In one or more arrangements, as is shown, resource interface 46 includes a recommended resource section 130 configured to display a list of resources recommended for the user, for example, based on available information on the user (e.g., information provided in questionaires, indicated goals/priorities, determined personality type, or any other available information). In some arrangements, the list of resources in section 130 may be automatically rearranged and/or prioritized by system 10 (e.g., to position resources determined by highest priority first in the list).

### Favorite Resource Section 132:

In one or more arrangements, as is shown, resource interface 46 includes a favorite resources section 132 configured to display a list of resources utilized by the user. In some arrangements, favorite resources section 132 may list resources that have been saved by the user and/or have been expressly marked as favorite by the user. Additionally or alternatively, in some arrangements, favorite resources section 132 may list resources that have been identified as being frequently and/or recently used by the user. Additionally or alternatively, in some arrangements, the list of resources in section 132 may be automatically rearranged and/or prioritized by system 10 (e.g., to position more frequently utilized resources (or resources selected on other criteria) closer to the front of the list so they may be accessed more easily by the user).

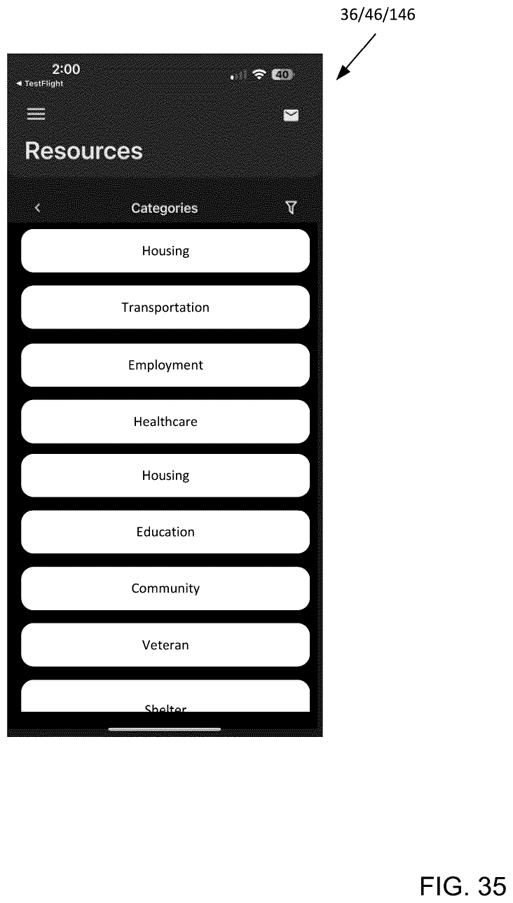

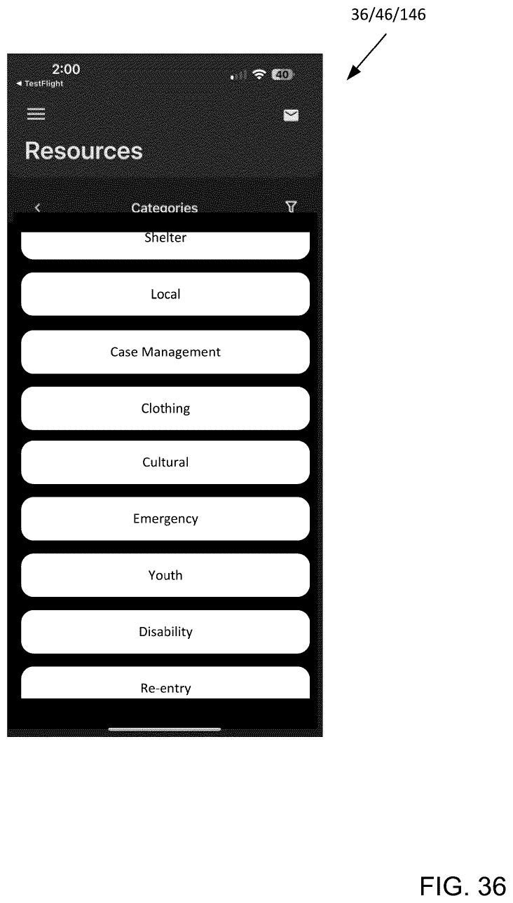

In one or more arrangements, as is shown, resource interface 46 includes one or more buttons 144 for a user to view interface screen 146 with a listing of all resources for selection by a user. FIGS. 35-36 show screenshots of an example interface screen 146 with a listing of all resources, in accordance with one or more arrangements. In this illustrative example, interface screen 146 provides a scrollable list of resources that may be selected by a user by pressing the desired resource.

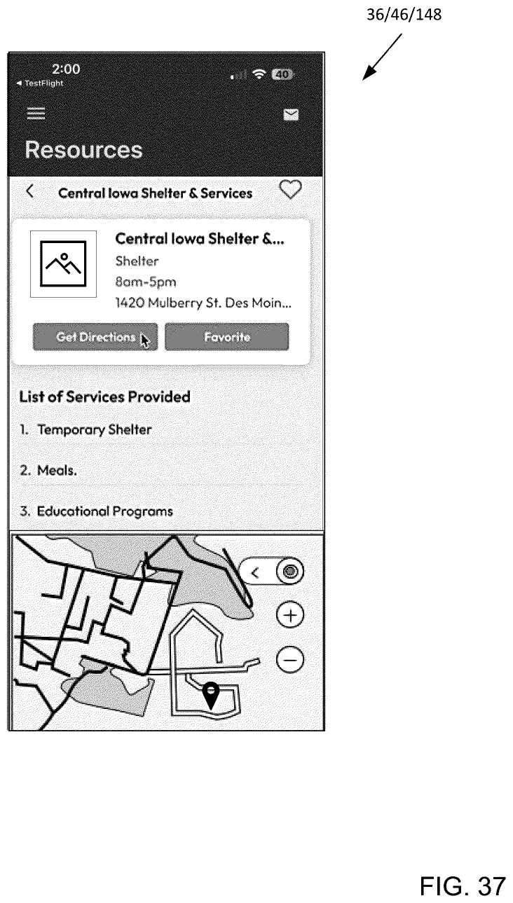

FIG. 37 shows a screenshot of an example interface screen 148 that may be displayed in response to a user selecting a particular resource (e.g., via resource interface 46, dashboard 42, or other means for resource selection). In this illustrative example, interface screen 148 displays information for a selected shelter category resource. In some various arrangements, as is shown, interface screen 148 may be configured to display various information for a particular resource including but not limited to, for example, name and/or description of the resource, hours of operation, list of services provided, address of the resource, graphic illustration of resource location, or any other relevant information.

### Nearby Resource Section 136:

In one or more arrangements, as is shown, resource interface 46 includes a nearby resources section 134 configured to display resources based on location. In one or more arrangements, as is shown, user resource section 72 includes a graphical map interface 138 similar to map interface 76 described with reference to dashboard interface 42. In this example arrangement, map interface 138 includes geomarkers showing locations of a user's selected resources relative to a current location. This graphical map interface 318 can make it easy for a user to assess which resources are nearby and/or assist in navigating to resources. In one or more arrangements, nearby resource section 136 includes a pull up list interface 140 (not shown) showing a listing of nearby resources of a user. In one or more arrangements, a user can select a resource from the pull up list interface 140, for example, to view additional information for the resource and/or navigate to the resource. Additionally or alternatively, in some arrangements, nearby resource section 136 may include a search bar interface to permit a user to search for additional resources (e.g., by name, location, type of service, or any other search criteria).

### Resources Category Section 134:

In one or more arrangements, as is shown, resource interface 46 includes a resources category section 134 configured to display a list of different categories of resources to facilitate browsing of available resources. In this example arrangement, a user may select one or categories to bring up a listing and/or description of available resources in the selected category.

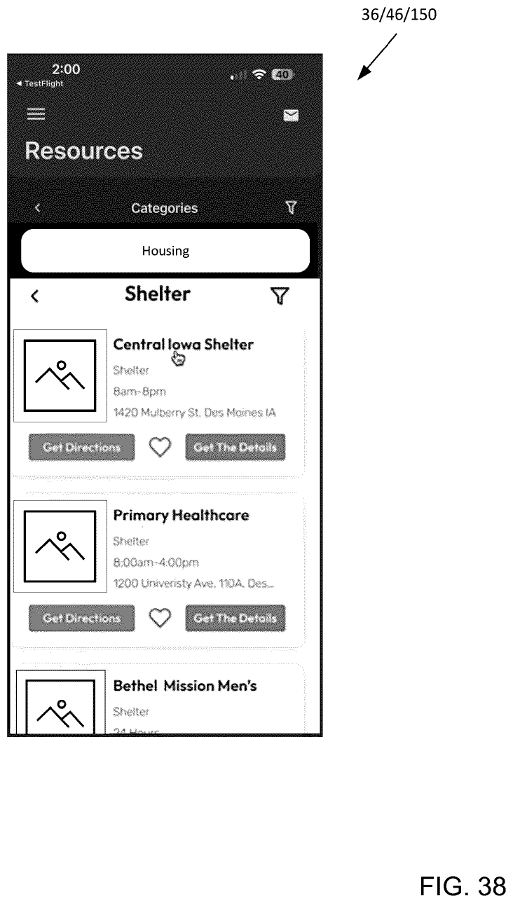

FIG. 38 shows a screenshot of an example interface screen 150 that may be displayed in response to a user selecting a particular resource category (e.g., via interface screen 146 or other means for resource selection). In this illustrative example, interface screen 150 provides a scrollable list of resources that may be selected by a user to view additional information on the resource (e.g., via interfaced screen 150 as shown in FIGS. 35-36).

### Community Resource Interface 160:

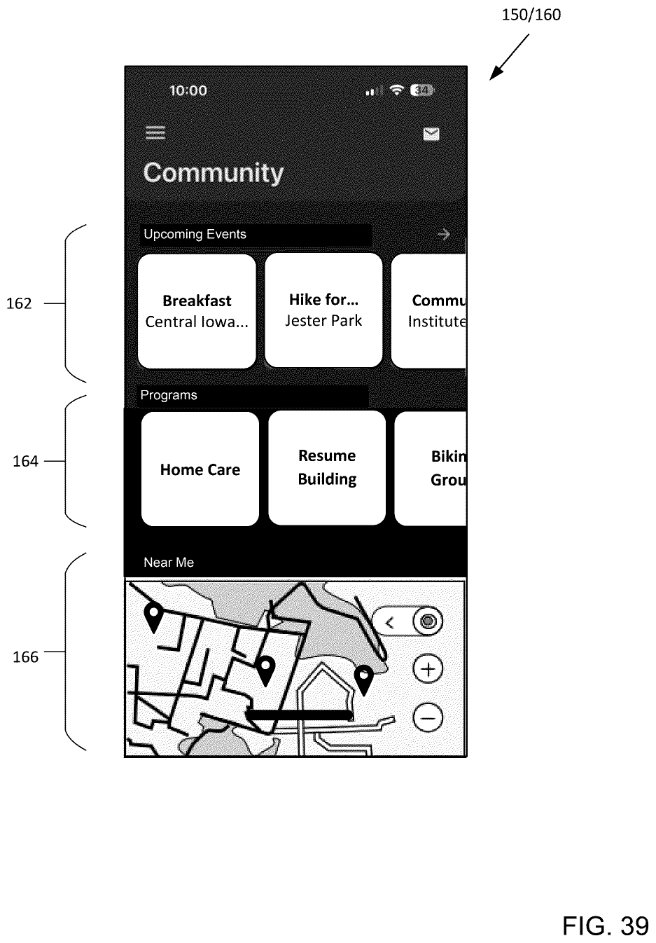

In one or more arrangements, resource interface 46 includes a community resource interface 160 to facilitate review and/or utilization of community type resources. FIG. 39 shows a screenshot of an example community resource interface 160 that may be displayed, for example, in response to a user selecting to view community resources via interfaced screen 150 or other selection means.

In one or more arrangements, as is shown, community resource interface 160 includes an upcoming events section 162 configured to display a list of upcoming events in the general area and/or at resources saved/previously utilized by a user. In one or more arrangements, as is shown, community resource interface 160 includes a program section 164 configured to display a list of available programs of resources in the general area and/or at resources saved/previously utilized by a user.

In one or more arrangements, as is shown, community resource interface 160 also includes a nearby resources section 166, configured to show nearby community resources (e.g., events/programs). Nearby resources section 166 may be implemented to be similar to nearby resources section 136 but configured to restrict displayed results to community type resources. In this example arrangement, nearby resources section 166 includes a map interface with geomarkers showing locations of nearby community resources relative to the current location. This graphical map interface can make it easy for a user to assess which community resources are nearby and/or assist in navigating to resources. In one or more arrangements, nearby resource section 166 includes a pull up list interface (not shown) showing a listing of nearby resources of a user. In one or more arrangements, a user can select a resource from the pull up list interface 140 or map interface, for example, to view additional information for the community resource and/or navigate to the community resource. Additionally or alternatively, in some arrangements, nearby resource section 166 may include a search bar interface to permit a user to search for additional resources (e.g., by name, location, type of service, or any other search criteria).

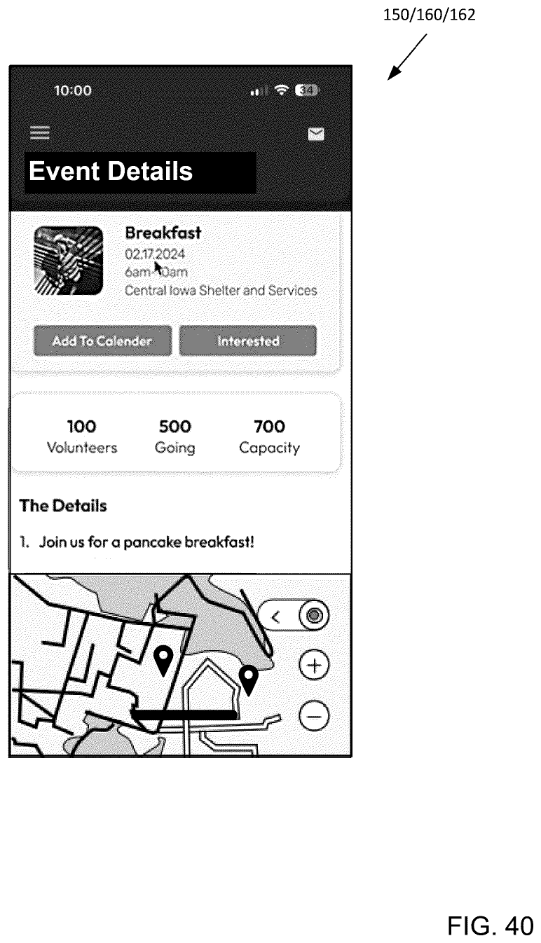

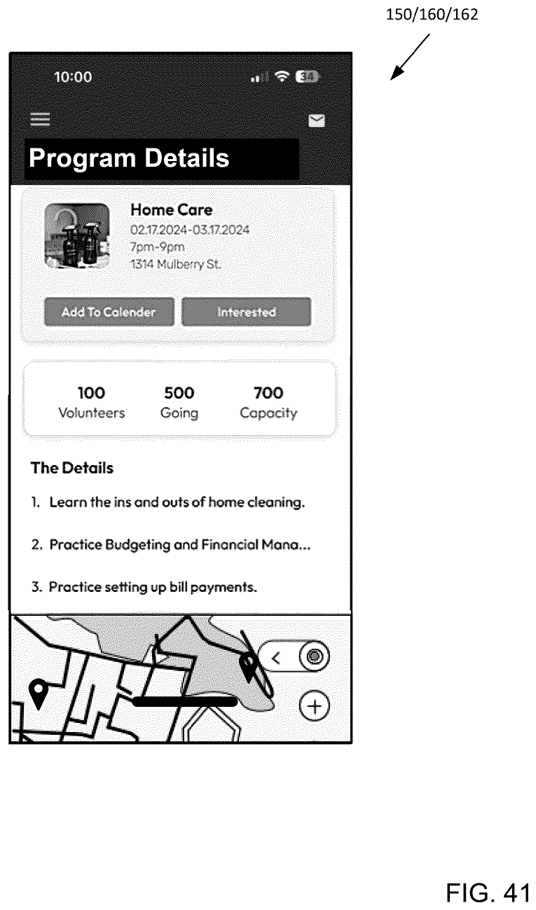

FIGS. 40-41 show screenshots of example interface screens 162 that may be displayed in response to a user selecting a particular community resource (e.g., via resource interface 160, dashboard 42, or other means for resource selection). In this example arrangement, FIG. 40 shows an example interface screen 162 for an example event and FIG. 41 shows an example interface screen 162 for an example program. However, the arrangements are not so limited. Rather, it is envisioned that in some various arrangements, example interface screens 162 may be adapted for use with any type of resource/program/event.

In this illustrative example, interface screen 162 displays information for a selected shelter category resource. In some various arrangements, as is shown, interface screen 162 may be configured to display various information for a particular resource including but not limited to, for example, name and/or description of the community resource/program/event, time/hours, list of services/activities, address of the resource/program/event, graphic illustration of location, or any other relevant information.

### Communication Interface(s) 50

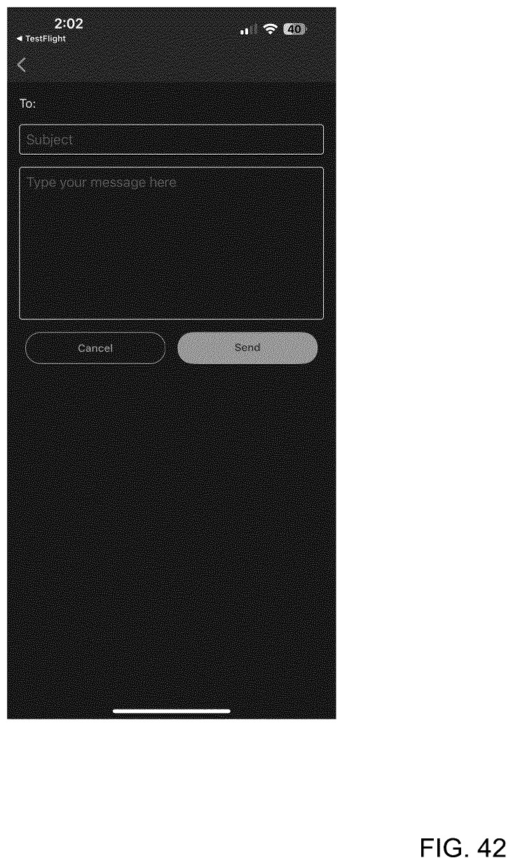

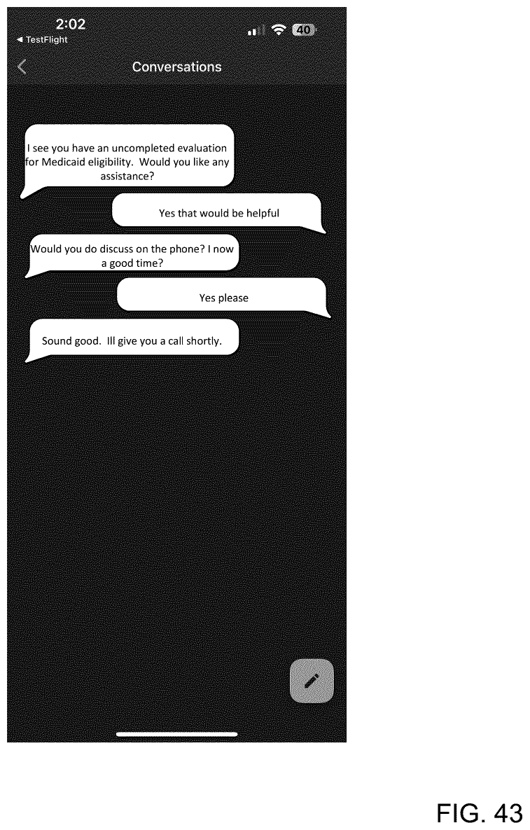

In one or more arrangements, user interface(s) 36 includes a communication interface 50. Communication interface 50 is formed of any suitable size, shape, and design and is configured to facilitate communication between clients, case managers, providers of services, and/or other users of system 10. FIGS. 42-43 show screenshots of example communication interfaces 60 that may be provided by client user interface 36 to facilitate communication between client users, case managers, and/or other persons (e.g., third party service providers). In this example, FIG. 42 shows a communication interface 60 configured to facilitate communication via email and FIG. 43 shows a communication interface 60 configured to facilitate communication via a chat interface (e.g., SMS/Messaging). However, the arrangements are not so limited. Rather, it is envisioned that in some various arrangements, client user interface 36 may include communication interfaces 60 configured various forms of communication including but not limited to, for example, email, chat messaging, video calls, phone calls, or any other method or means of communication.

### Case Manager User Interface 36:

For ease of explanation, front end system 16 may be primarily described with reference to a client user interface 36 for use by client users (e.g., as shown in FIGS. 5-43. However, the arrangements are not so limited. In one or more arrangements, front end system 16 is configured to provide a case manager user interface 36.

Case manager user interface 36 may be formed of any suitable size shape and design and is configured to facilitate review and processing of data for client user and/or support services, for example, to facilitate client user access to and/management of providing access to and/or management of support services for prevention and/or mitigation of homelessness. In one or more arrangements, case manager user interface 36 provides interfaces to review various client data, including but not limited to, for example, contact information, answers to questionnaires, available resources of client users, goals selected by client users, progress made toward completion of goals, support resources registered for and/or utilized by client users, or any other relevant information. In one or more arrangements, case manager user interface 36 is configured to track and organize client user data to enable case managers to more efficiently track and better help client users to obtain access to support services to empower client users on the path to self-sufficiency. In this manner, case managers can better apply and prioritize their resources to the needs of client users and improve scalability of their services.

In one or more arrangements, case manager user interface 36 provides a communication interface (e.g., communication interface 50) to facilitate efficient communication with client users via one or more communication channels (e.g., such as email, chat messaging, video calls, phone calls, or any other method or means of communication). In one or more arrangements, system 10 is configured to store the methods of communication that are preferred by different client users. In one or more arrangements, case manager user interface 36 is configured to adaptively reconfigure the interface when viewing data of a client user to enable/suggest the method of contact that is preferred by the client user. In one or more arrangements, system 10 is configured to determine personality type of client users and set a preferred method of contact based on the determined personality type.

### Data Processing System 200:

Various blocks, modules, or other circuits of the back end system 14 and front end system 16 may be implemented to carry out one or more of the operations and activities described herein and/or shown in the figures. In these contexts, a “block” (also sometimes “logic circuit,” “control circuit,” “processing circuit,” “server,” “module,” “data processing system” or “system”) is a circuit specifically configured to carry out one or more of these or related operations/activities. For example, such circuits may be discrete logic circuits or programmable logic circuits configured and arranged for implementing these operations/activities, as shown in the figures and/or described in the specification. In certain embodiments, such a programmable circuit may include one or more programmable integrated circuits (e.g., field programmable gate arrays and/or programmable ICs). Additionally or alternatively, such a programmable circuit may include one or more processing circuits (e.g., a computer, tablet, microcontroller, system-on-chip, smart phone, server, and/or cloud computing resources). For instance, computer processing circuits may be programmed to execute a set (or sets) of instructions (and/or configuration data). The instructions (and/or configuration data) can be in the form of firmware or software stored in and accessible from a memory (circuit). Certain aspects are directed to a computer program product (e.g., nonvolatile memory device), which includes a machine or computer-readable medium having stored thereon instructions which may be executed by a computer (or other electronic device) to perform these operations/activities.

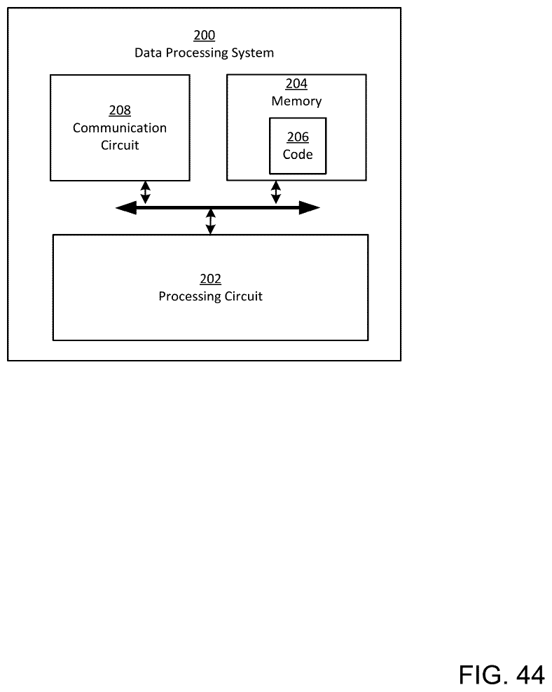

FIG. 44 shows an example data processing system 200 that may be used to implement systems, circuits, components, and/or processes of back end system 14 and front end systems 16, in accordance with one or more arrangements. Data processing system 200 is formed of any suitable size, shape, design, and/or technology and is configured to carry out the one or more of these or related operations/activities described herein. In the arrangement shown, as one example, data processing system 200 includes a processing circuit 202 and memory 204 having software code 206 or instructions that facilitates the processing and/or display of information, and a communication circuit 208, among other components.

Processing circuit 202 may be any computing device that receives and processes information and outputs commands according to software code 206 or instructions stored in memory 204. Memory 204 may be any form of information storage such as flash memory, ram memory, dram memory, a hard drive, or any other form of memory. Processing circuit 202 and memory 204 may be formed of a single combined unit. Alternatively, processing circuit 202 and memory 204 may be formed of separate but electrically connected components. Alternatively, processing circuit 202 and memory 204 may each be formed of multiple separate but electrically connected components.

Software code 206 or instructions is any form of information or rules that direct processing circuit 202 how to receive, interpret, and respond to information to operate as described herein. Software code 206 or instructions is stored in memory 204 and accessible to processing circuit 202. As an illustrative example, in one or more arrangements, software code or instructions may configure processing circuit 202 to interact with users via front end systems 16 and perform various processes in response to user input.

Communication circuit 208 is formed of any suitable size, shape, design, and/or technology and is configured to facilitate communication with back end system 14. In one or more arrangements, as one example, communication circuit 208 includes a transceiver circuit and an antenna. A transceiver is any electronic device that facilitates two-way communication, that is, the delivery of information between data processing system 200 and other components of the system 10. An antenna is any device that is configured to receive wireless signals from over-the-air communication and/or transmit wireless signals in over-the-air communication. In an example arrangement, a transceiver of communication circuit 208 is connected with a respective antenna, which may be a monopole antenna, dipole antenna, a loop antenna, a fractal antenna, or any other form of an antenna, to facilitate transmission and/or reception of signals in the form of electromagnetic radio frequencies. Additionally or alternatively, the transceiver of communication circuit 208 may be configured to communicate over a wired communication channel.

In various arrangements, communication circuit 208 may be configured to communicate with various components of system 10 using various wired and/or wireless communication technologies and protocols over various networks and/or mediums including but not limited to, for example, Serial Data Interface 12 (SDI-12), UART, Serial Peripheral Interface, PCI/PCIe, Serial ATA, ARM Advanced Microcontroller Bus Architecture (AMBA), USB, Firewire, RFID, Near Field Communication (NFC), infrared and optical communication, 802.3/Ethernet, 802.11/WIFI, Wi-Max, Bluetooth, Bluetooth low energy, UltraWideband (UWB), 802.15.4/ZigBee, ZWave, GSM/EDGE, UMTS/HSPA+/HSDPA, CDMA, LTE, 4G, 5G, FM/VHF/UHF networks, and/or any other communication protocol, technology or network.

Although in some arrangements, various circuits, components, systems, programs, or processes of back end system 14, front end system 16, or other portions of system 10 may be primarily described or shown as being implemented together on the same system, machine, network, program or process, the arrangements are not so limited. Rather it is contemplated that such components, systems, programs, or processes of back end system 14, front end system 16 or other portions go system 10 may be implemented separately on by separate processes or programs and/or on separate circuits, systems, and/or components on the same bus or network or communicatively connected between different networks. Conversely, although in some arrangements, various circuits, components, systems, programs, or processes of back end system 14, front end system 16, or other portions of system 10 may be primarily described or shown as being implemented separately, the arrangements are not so limited. Rather it is contemplated that such components, systems, programs, or processes of back end system 14, front end system 16 or other portions of system 10 may be implemented together on by the same processes or program and/or on the same circuit, system, and/or component on the same bus or network or communicatively connected between different networks.

It will be appreciated by those skilled in the art that other various modifications could be made to the device without parting from the spirit and scope of this disclosure. All such modifications and changes fall within the scope of the claims and are intended to be covered thereby.

1. A system for providing access to and/or management of support services for prevention and/or mitigation of homelessness, comprising:
a front end system;
the front end system including one or more web servers;
the one or more web servers configured to provide one or more user interfaces;
a back end system;
the back end system communicatively connected to the front end system;
wherein the back end system includes a data server;
wherein the back end system includes a processing server;
the processing server configured to store data for a client user relating to eligibility for, availability of, and/or utilization of a plurality of support services;
wherein the one or more interfaces includes a client user interface;
wherein the client user interface is configured to permit the client user to access the data stored in the processing server to facilitate review of information for the plurality of support services.

2. The system of claim 1, wherein the client user interface is configured to prompt the user to select at least one goal;
wherein the system is configured to generate a list of tasks to be completed by the client user to move user toward the at least one goal.

3. The system of claim 1, wherein the client user interface is configured to prompt the user to select at least one goal;
wherein the system is configured to generate a list of tasks to be completed by the client user to move user toward the at least one goal;
wherein the list of tasks includes a set of tasks configured to facilitate providing the client user access to one or more of the plurality of support services.

4. The system of claim 1, wherein for at least one client user of the plurality of client users, the system is configured to determine a personality type of the client user;
wherein the system is configured to automatically adjust one or more settings for the client user based on the determined personality type.

5. The system of claim 1, wherein the client user interface is configured to prompt the user to answer a set of questions related to resources available to the client user;
wherein the client user interface is configured to display a list of recommended support services of the plurality of support services;
wherein the list of recommended support services are selected based on the client user's answers to the set of questions;
wherein the list of recommended support services provide access to one or more resources that are not available to the client user.

6. The system of claim 1, wherein the client user interface is configured to display a list of recommended support services of the plurality of support services;
wherein the list of recommended support services are generated based on the data for the client user stored by the processing server.

7. The system of claim 1, wherein the client user interface is configured to display a list of recommended support services of the plurality of support services;
wherein the system is configured to determine respective priorities for list of recommended support services based on the data for the client user stored by the processing server;
wherein the client user interface is configured to automatically rearrange an order in which the list of recommended support services is displayed based on the determine respective priorities.

8. The system of claim 1, wherein the client user interface is configured to display a list of the plurality of support services;
wherein the client user interface is configured to automatically rearrange an order in which the list of the plurality of support services is displayed based on how recently the plurality of support services have been accessed by the client user via the client user interface.

9. The system of claim 1, wherein the client user interface is configured to display a list of the plurality of support services;
wherein the client user interface is configured to automatically rearrange an order in which the list of the plurality of support services is displayed based on how recently the plurality of support services have been accessed by the client user via the client user interface.

10. The system of claim 1, wherein the system is configured to determine a personality type of the client user;
wherein the system is configured to automatically adjust one or more settings for the client user based on the determined personality type.

11. The system of claim 1, wherein the system is configured to determine a personality type of the client user;
wherein the system is configured to determine wherein the client user interface is configured to display a list of recommended support services of the plurality of support services;
wherein the list of recommended support services is selected from the plurality of support services based on the recommended personality type.

12. The system of claim 1, wherein the one or more interfaces includes a case manager user interface;
wherein the case manager user interface is configured to permit a case manager for the client user to access the data stored in the processing server for the client user.

13. The system of claim 1, wherein the client user interface is configured to prompt the user to select at least one goal;
wherein the system is configured to generate a list of tasks to be completed by the client user to move user toward the at least one goal;
wherein the one or more interfaces includes a case manager user interface;
wherein the case manager user interface is configured to permit a case manager for the client user to view information indicating the client users progress in completion of the list of tasks.

14. The system of claim 1, wherein the one or more interfaces includes a case manager user interface;
wherein the case manager user interface and the client user interface are configure to provide a communication channel between the client user and a case manager for the client;
wherein the communication channel facilitates communication via voice calls, email, messaging, and/or video calls.

15. The system of claim 1, wherein the one or more interfaces includes a case manager user interface;
wherein the client user interface includes a mechanism for the client user to permit their location to be shared with a case manager;
wherein in response to the client user permitting their location to be shared with a case manager, the case manager user interface is configured to display the location of the client user to the case manager.

16. A system for providing access to and/or management of support services for prevention and/or mitigation of homelessness, comprising:
a front end system;
the front end system including one or more web servers;
the one or more web servers configured to provide one or more user interfaces;
a back end system;
the back end system communicatively connected to the front end system;
wherein the back end system includes a data server;
wherein the back end system includes a processing server;
the processing server configured to store data for a client user relating to eligibility for, availability of, and/or utilization of a plurality of support services;
wherein the one or more interfaces includes a client user interface;
wherein the client user interface is configured to permit the client user to access the data stored in the processing server to facilitate review of information for the plurality of support services;
wherein the system is configured to generate a list of recommended support services of the plurality of support services based on geographic location of the client user;
wherein the client user interface is configured to display the list of recommended support services.

17. The system of claim 16, wherein the client user interface is configured to prompt the user to select one or more goals;
wherein the system is configured to generate the list of recommended support services of the plurality of support services based on the selected one or more goals.

18. The system of claim 16, wherein the system is configured to determine a personality type of the client user;
wherein the system is configured to generate the list of recommended support services of the plurality of support services based on the determined personality type.

19. The system of claim 16, wherein the client user interface is configured to display a list of recommended support services of the plurality of support services;
wherein the list of recommended support services are generated based on the data for the client user stored by the processing server.

20. The system of claim 16, wherein the client user interface is configured to display a list of recommended support services of the plurality of support services;
wherein the system is configured to determine respective priorities for list of recommended support services based on the data for the client user stored by the processing server;
wherein the client user interface is configured to automatically rearrange an order in which the list of recommended support services is displayed based on the determine respective priorities.
